(19) United States
(12) Patent Application Publication
(10) Pub. No.: US 2025/0257552 A1
(43) Pub. Date: Aug. 14, 2025

(54) SYSTEM AND METHOD FOR GENERATING FRESHWATER FROM ATMOSPHERIC MOISTURE ABOVE OCEAN SURFACES

(71) Applicant: The Board of Trustees of the University of Illinois, Urbana, IL (US)

(72) Inventors: Praveen KUMAR, Champaign, IL (US); Francina DOMINGUEZ, Champaign, IL (US); Afeefa RAHMAN, Urbana, IL (US)

(21) Appl. No.: 18/855,040

(22) PCT Filed: Apr. 12, 2023
(86) PCT No.: PCT/US2023/065663

§ 371 Date: Oct. 8, 2024

Related U.S. Application Data
(60) Provisional application No. 63/330,591, filed on Apr. 13, 2022.

(51) Int. Cl. E03B 3/28; B63J 1/00

(52) U.S. Cl. CPC E03B 3/28; B63J 1/00

(57) ABSTRACT

A system for fresh water generation may comprise an intake device positioned above an ocean or sea surface for capture of moisture-laden air. The system may comprise a condenser in fluid communication with the intake device for condensation of liquid water from the moisture-laden air captured by the intake device. The intake device may be disposed at or moveable to a vertical position above the ocean or sea surface where moisture flux of the moisture-laden air is at or above a predetermined value.

### RELATED APPLICATIONS

The present patent document claims the benefit of priority under 35 U.S.C. § 119(e) to U.S. Provisional Patent Application No. 63/330,591, which was filed on Apr. 13, 2022, and is hereby incorporated by reference in its entirety.

### TECHNICAL FIELD

The present disclosure is related generally to water generation and more specifically to a system to capture, transport, and condense atmospheric moisture from ocean surfaces.

### BACKGROUND

Lack of access to freshwater across vast regions of the globe poses a grand challenge that needs bold and immediate solution. Current approaches of addressing this challenge primarily by reducing and managing demand are proving inadequate as population and economic growth quickly absorb any capacity that is created through these measures. Recycling and reuse of water have had noticeable success but inherently have limited scalability because they are fundamentally constrained by the available supply. Effective solutions to increase the supply are at present limited or they are practically non-existent since all resources are being exploited beyond sustainable capacity or rapidly dwindling due to climate change. For example, groundwater is being extracted far beyond renewable rates and groundwater table is falling at alarming rates in regions where water is needed most. Snowpack and glaciers that serve as water towers are thinning or receding under climate change, with snowmelt occurring earlier in the spring season that before. Regions that are already water limited are becoming more so as climate driven changes are creating further scarcity through reduced precipitation, increased evaporation, or both. Options for fulfilling this increased need through transport from distant areas are also becoming increasingly less viable due to decrease in the availability of water in the source regions. The Southwestern United States is a compelling example of these challenges where water level in the Colorado River reservoirs have been reducing during the past decades reaching critically low levels during the summer of 2021, threatening both the water resources and power systems. Many examples of such cascading influences exist around the globe.

### BRIEF SUMMARY

A system and method for freshwater generation from atmospheric moisture above ocean surfaces is described in this disclosure.

The system comprises an intake device positioned above an ocean or sea surface for capture of moisture-laden air. The system comprises a condenser in fluid communication with the intake device for condensation of liquid water from the moisture-laden air captured by the intake device. The intake device is disposed at or moveable to a vertical position above the ocean or sea surface where moisture flux of the moisture-laden air is at or above a predetermined value.

The method comprises positioning an intake device at a vertical position above an ocean or sea surface where moisture flux of moisture-laden air is at or above a predetermined value. The method comprises capturing the moisture-laden air in the intake device positioned above an ocean or sea surface. The method comprises directing the captured moisture-laden air to a condenser. The method comprises condensing water vapor from the moisture-laden air to form liquid water with the condenser.

### BRIEF DESCRIPTION OF THE DRAWINGS

FIGS. 1A-1E illustrate an example of a freshwater generation system,

FIGS. 2A-2D illustrate another example of a freshwater generation system,

FIGS. 3A-3D illustrate another example of a freshwater generation system,

FIGS. 4A-4E illustrate another example of a freshwater generation system,

FIGS. 5A and 5B illustrate another example of a freshwater generation system,

FIG. 6 illustrates another example of a freshwater generation system,

FIG. 7 illustrates an example of a condenser for freshwater generation,

FIGS. 8A and 8B illustrate an example of an intake device of a freshwater generation system,

FIG. 9 illustrates another example of an intake device of a freshwater generation system,

FIG. 10 illustrates another example of a freshwater generation system,

FIG. 11 illustrates another example of a freshwater generation system,

FIG. 12 illustrates another example of a freshwater generation system,

FIG. 13 illustrates another example of a freshwater generation system,

FIG. 14 illustrates a graph related to moisture flux,

FIGS. 15A-15E illustrate a graph related to moisture flux at different geographic locations,

FIG. 16 illustrates a graph related to potential water yield across the world,

FIGS. 17A-17E illustrate another graph related to moisture flux, and

FIGS. 18A-18C illustrate another graph related to moisture flux.

### DETAILED DESCRIPTION

The system and method described herein may generate freshwater through the capture of moisture-laden air from above the surface of the ocean or sea and through the condensation of the captured air. The system may provide freshwater to water-stressed parts of the globe that do not have other sources of freshwater or where other solutions are not feasible. The system may utilize the atmosphere above oceans and seas, for example, above oceans proximal to land, where there is a substantially limitless supply of water vapor. The near-surface environment above the ocean or sea has high humidity. The system may capture the water vapor in this high humidity, moisture-laden air to generate freshwater. The figures describe below show various embodiments of this system.

Certain embodiments may include capturing water vapor from the atmosphere above the ocean surface and transporting the moisture laden air to land where its condensation can provide freshwater. Near-surface environments above the ocean have high humidity whose daily and seasonal variations are driven largely by the temperature of the oceanic surface and that of the air above. The former determines the evaporative capacity from the ocean while the latter determines the saturated moisture holding capacity of the atmosphere. Variations in these temperatures, and hence the humidity in the atmosphere, are largely determined by the variation of solar radiation and wind velocities. For water stressed areas of the globe that are proximal to oceans, significant generation of such a freshwater supply is not only viable but offers a scalable approach for addressing water security challenges. In essence, the freshwater generation system described herein mimics the natural physical process of the hydrologic cycle by which evaporation from the ocean is transported inland, cools and condenses to then fall on the land surface as precipitation, except it is proposed to engineer the pathway through which the evaporated moisture moves, thus controlling the location of where the water is made available through controlled condensation.

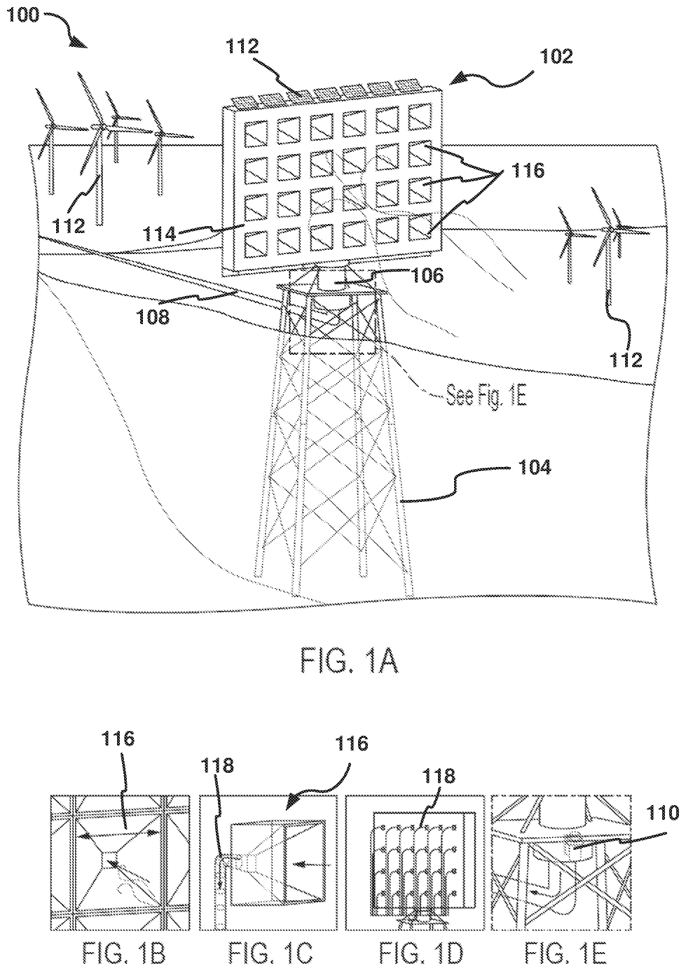

FIGS. 1A-1E illustrate an example of the freshwater generation system 100. The freshwater generation system 100 may include an intake device 102, a support structure 104, a condenser 106, a main conduit 108, a pump 110, and a power generation system 112. The intake device 102 may include a capture surface 114, capture cells 116, and collection conduits 118.

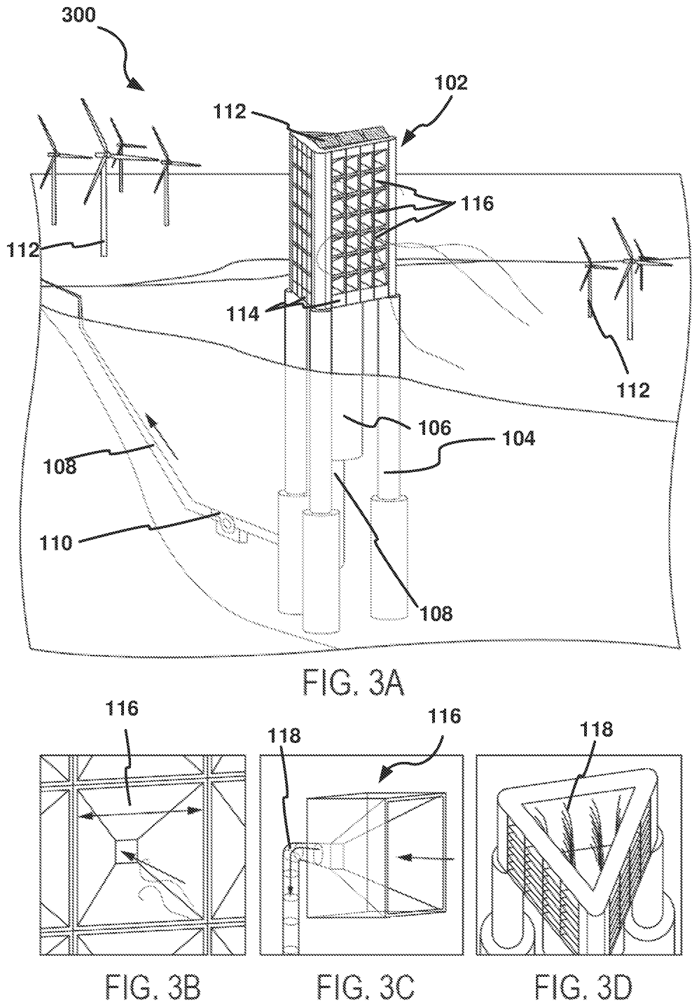

The intake device 102 may be a relatively large structure, for example, a structure with a height of up to 100 meters and a width of up to 210 meters. The intake device 102 may be shaped so as to optimize the amount of wind or air that can be captured for use by the freshwater generation system 100. For example, the intake device 102 may be a rectangular prism, frustopyramidal, frustroconical or cuboidal in shape as shown in FIGS. 1, 2, and 5. Alternatively, the intake device 102 may be shaped like a triangular prism as shown in FIGS. 3, 4, and 6. Alternatively, the intake device 102 may be any other shape suitable for capturing air or wind for use by the freshwater generation system 100.

The intake device 102 may have a large surface area facing outward to capture air and wind. The surface area of the intake device 102 may include the capture surface 114. In other words, the capture surface may be a non-planar, curved or multi-faceted surface comprising one or more features or depressions (e.g., the capture cells 116 referred to below) configured for capture of moisture-laden air. The capture surface 114 may, for example, be a single surface, for example, a side of the intake device 102. Alternatively, the intake device 102 may have multiple capture surfaces 114 disposed on different sides or different surfaces of the intake device 102. For example, the intake device 102 may be shaped like a rectangular or triangular prism, and the capture surfaces 114 may be the vertical sides of the prism shaped intake device 102.

The intake device 102 may be, for example, cuboidal in shape, with the capture surface 114 disposed on the main, or largest, rectangular side of the intake device 102. For example, the capture surface 114 may be disposed on the vertical, rectangular side of the intake device 102 with the largest height and width dimensions of the intake device 102. Additionally or alternatively, a capture surface 114 may be disposed on multiple sides of the intake device 102, for example, on multiple outward facing sides of the intake device 102. The capture surface 114 may be a surface of the intake device 102 that is directed to face into the wind such that the wind or air currents blow air into the capture surface 114.

The intake device 102 may be positioned off the shore of a proximal landmass. The location of the intake device 102 may be based on a calculated moisture flux or the rate at which water vapor moves horizontally per a unit of vertical area per a unit of time. Intake devices 102 may be positioned in areas where the amount of atmospheric moisture above the surface of the ocean or sea is determined to be sufficient.

The intake device 102 and the capture surface 114 may be made up of one or more capture cells 116. The capture cells 116 may be any structure shaped to capture wind or air and direct or funnel the air into the collection conduits 118. The capture cells 116 may be depressions in the capture surface 114. For example, the capture cells 116 may be frustopyramidal or frustoconical funnels that extend from the capture surface 114 inward into the body of the intake device 102. The intake device 102 and capture surface 114 may have multiple capture cells 116, for example, capture cells 116 may be arranged in a grid array or in parallel rows on the capture surface 114. Alternatively, the intake device 102 may have a single large capture cell 116. The one or more capture cells 116 may be integrally formed with the capture surface 114. Alternatively, the capture surface 114 may have a multi-piece structure. For example, the one or more capture cells 116 may be separately formed and secured together to form the capture surface 114.

The collection conduits 118 may be any structure, for example, pipes or tubes, capable of funneling the air or wind collected by the capture surface 114 and capture cells 116. The capture cells 116 may be in fluid communication with the collection tubes 118. For example, each capture cell 116 may have a collection conduit 118 attached to the back of the capture cell 116, where the front of the capture cell 116 is the end of the capture cell 116 at the intake surface 114 and the back of the capture cell 116 is a surface of the intake device 102 opposite from the capture surface 114. In this disclosure, when a first component is described as being “in fluid communication” with a second component, it may be understood that the first and second components are connected directly or indirectly such that fluid can flow in one or both directions between and/or through the first and second components. The collection conduits 118 may all flow from respective capture cells 116 into a common line and be in fluid communication with an intake of the condenser 106. The collection conduits 118 may extend, for example, from the capture cells 116 to the condenser 106.

The support structure 104 may be attached to or integrally formed with the bottom of the intake device 102. The support structure 104 may be embedded in or secured to the floor of the ocean or sea. The support structure 104 may extend up from the floor of the ocean or sea to above the surface of the ocean or sea. The top of the support structure 104 may be, for example, 10 meters above the surface of the ocean or sea and may be connected to the intake device 102. The support structure 104 may be any structure capable of supporting and holding the intake device 102 above the surface of the ocean or sea. For example, the support structure 104 could have multiple beams or poles mounted in the ocean or sea bed extending substantially vertically to above the ocean or sea surface. Additional support beams or braces may extend between the vertical beams.

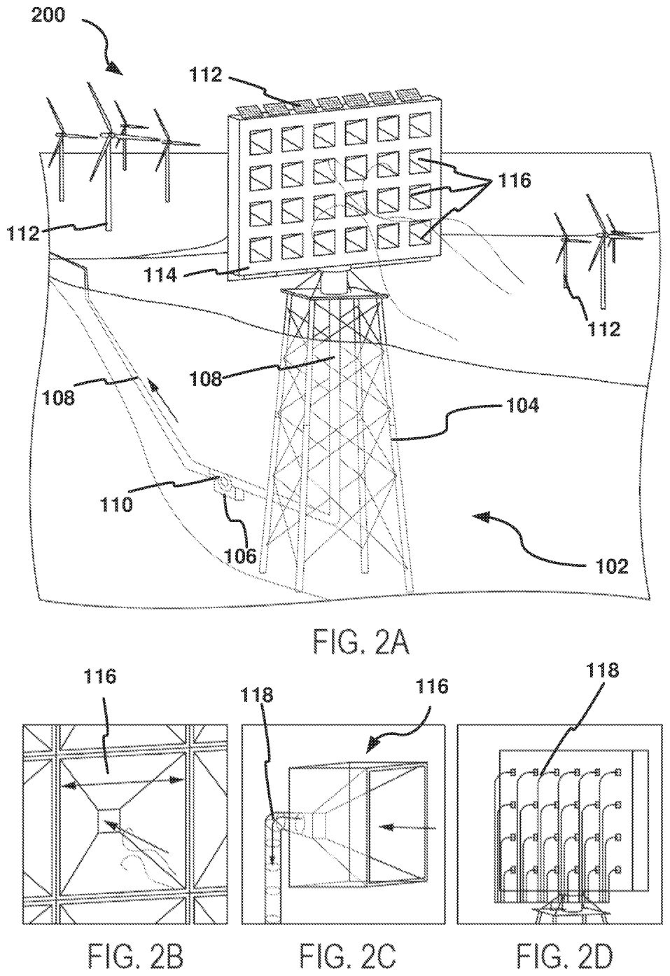

The condenser 106 may be any device capable of condensing water from the moisture-laden air. For example, the condenser 106 may be a refrigerant-based condenser using a liquid and/or vapor coolant through the condenser, a Peltier-based condenser using thermo-electric coolers on metal surfaces that chill when electricity is applied), a dessicant-based condenser where a solid or liquid material absorbs the moisture from the air, and then when energy is applied or other state change occurs to the dessicant, the moisture is released, or the condenser 106 may use hydrophilic or hydrophobic coatings where the surface attracts moisture and/or causes the moisture to bead up and slide off. In this example, the condenser 106 may utilize the surrounding ocean or sea water to cool and condense the moisture-laden air after delivery through the collection conduits 118 to an underwater condenser 106, as illustrated in FIGS. 2 and 3.

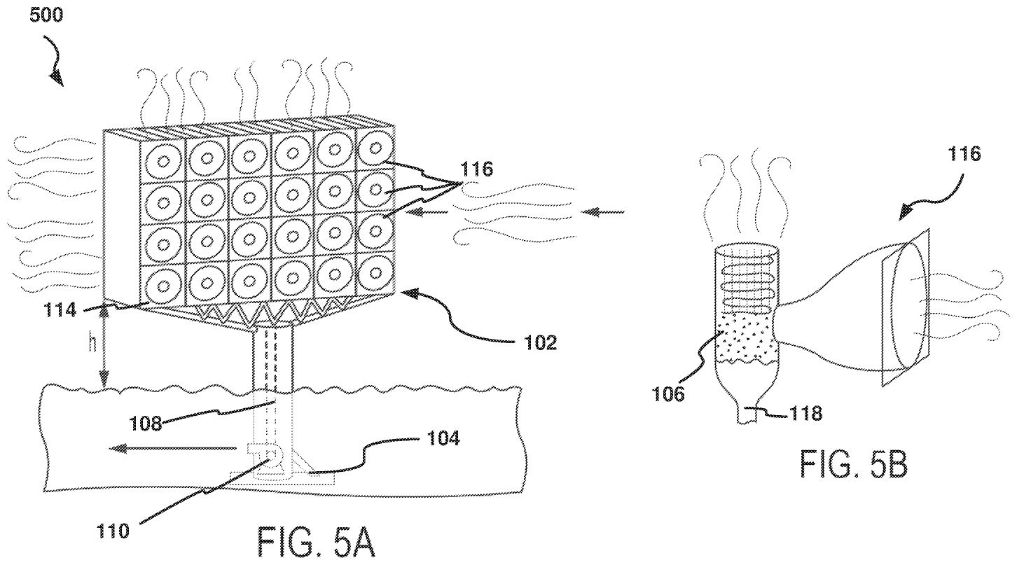

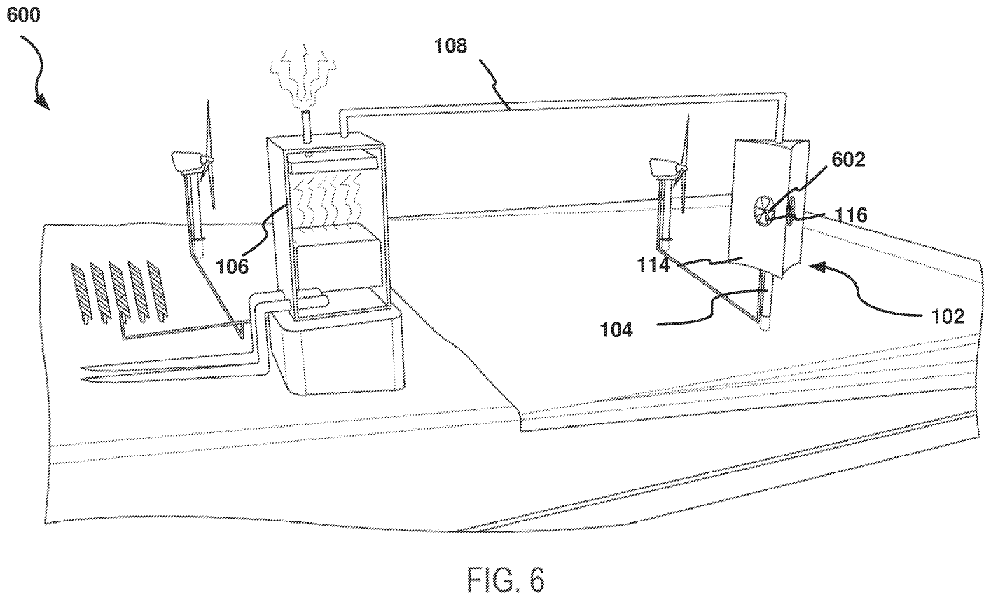

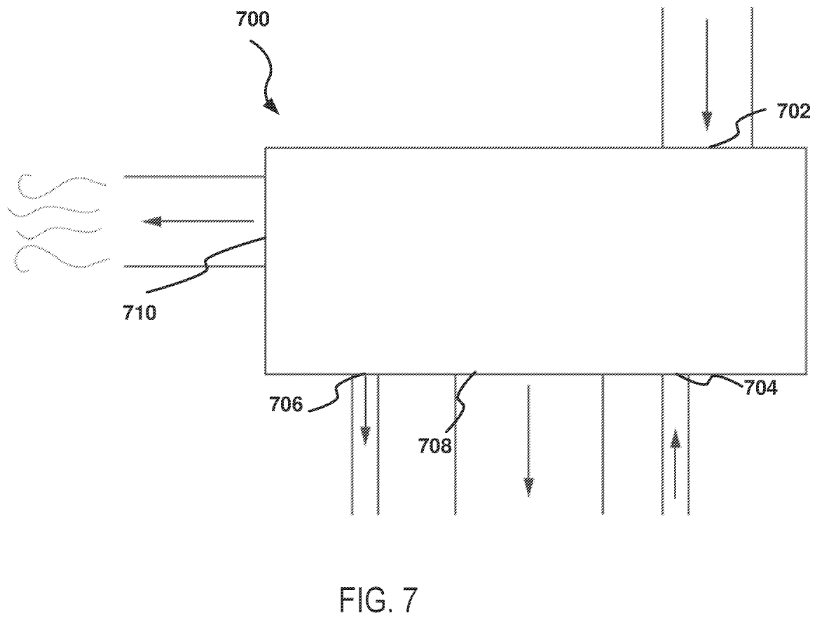

Additionally or alternatively, the condenser 106 may be integrated with the capture cells 116 and/or collection conduits 118 such that condensation occurs above the surrounding ocean or sea, as shown for example in FIGS. 1, 4 and 5. As shown in FIG. 5B, the captured air may blow straight through the condenser 106, for example, through the condenser's 106 coils, plates, and/or fins. The moist air may bead up and condense on the coils, plates, and/or fins, while the remaining air is exhausted out an exit of the condenser 106. The condenser 106 may be mounted on the intake device 102 and/or the support structure 104. For example, the condenser 106 may be mounted on top of the support structure 104 beneath the intake device 102 and capture surface 114. The collection conduits 118 may extend from the back of the capture cells 116 to an intake of the condenser 106. Additionally or alternatively, the condenser 106 may be along the main conduit 108. Alternatively, as shown in FIG. 6, the condenser 106 may be disposed at a destination point, for example, a collection tank or at a point on a near-by shore or proximal landmass.

The pump 110 may be any type of device suitable for driving or pumping fluids from the condenser 106 or intake device 102 to a determined destination, for example, a collection tank or to a point on a nearby shore. For example, the pump 110 may be a positive displacement pump, impulse pump, velocity pump, gravity pump, steam pump, valveless pump, centrifugal pump, or an axial-flow pump. The pump 110 may, for example, be positioned on the support structure 104, condenser 106, and/or on the intake device 102 and pump or push the condensed water or moisture-laden air towards a destination point, such as a collection tank. Alternatively, the pump 110 may be disposed near the destination point and pull or suction the condensed water or moisture-laden air toward the destination point.

The main conduit 108 may be any pipe or tubing capable of delivering the condensed water or moisture-laden air from the intake device 102, condenser 106, and/or support structure 104 to the destination point. For example, in an embodiment where the condenser 106 is positioned adjacent to the intake device 102, the main conduit 108 may be in fluid communication with and connect an output of the condenser 106 to the destination point and transport condensed water from the condenser 106 to the destination point, for example, a collection tank. Alternatively, if the condenser 106 is positioned near the destination point, the main conduit 108 may connect an outlet of the collection conduits 118 to the condenser 106. The main conduit 108 may be disposed above the surface of the ocean or sea. Alternatively, the main conduit 108 may be disposed underneath the ocean or sea, for example, along the bottom of the ocean or sea.

The freshwater generation system 100 may include a power generation system 112. The power generation system 112 may, for example, be a power generation system based wholly or partially on renewable energy. For example, the power generation system 112 may generate power from tidal energy, solar energy, and/or wind energy. The power generation system 112 may include one or more solar panels, wind turbines, wind mills, and/or tidal generators. Additionally or alternatively, the power generation system 112 may include another power source such as gas or electric power. The power generation system 112 may be configured to provide power to components of the freshwater generation system 100, for example, the intake device 102, the condenser 106, the pump 110, and/or any other components.

During operation of the freshwater generation system 100 shown in FIGS. 1A-1E, moisture-laden air or wind is captured by the capture cells 116 and funneled into the collection conduits 118. The air is directed along the collection conduits 118 and/or the main conduit 108 to the condenser 106 where the humid, moisture-laden air is condensed and the resulting water directed through the main conduit 108. The pump 110 may force the condensed water through the freshwater generation system 100 and through the main conduit 108 to the destination point, for example a collection tank or a point on a near-by shore. A freshwater generation system with an intake device 102 and having a capture surface 114 approximately 210 meters in width and 100 meters in height may capture 35 to 75 billion liters of freshwater per year.

FIGS. 2A-2D illustrate another example of a freshwater generation system 200. The freshwater generation system 200 of FIGS. 2A-2D may have the same or similar components and/or a different arrangement of the components of the freshwater generation system 100 shown in FIGS. 1A-1E. In FIGS. 2A-2D the main conduit 108 extends vertically downward from the intake device 102 down underneath the surface of the sea or ocean. For example, the main conduit may extend along the ocean or sea floor. The condenser 106 and pump 110 may be disposed underwater along the main conduit 108.

During operation, moisture-laden air may flow from the capture cells 116, though the collection conduits 118, down underneath the ocean or sea surface through the main conduit 108, to the condenser 106. The resulting condensed water may flow through the main conduit 108 to the destination point, for example, to a point on the near-by shore. The pump 110 may force the moisture-laden air from the intake device 102 to the condenser 106 and/or force the condensed water from the condenser 106 to the destination point.

FIGS. 3A-3D illustrate another example of a freshwater generation system 300. The freshwater generation system 300 of FIGS. 3A-3D may have the same or similar components and/or a different arrangement of the components of the freshwater generation systems 100 and 200 shown in FIGS. 1A-1E and 2A-2D. For example, the intake device 102 of FIGS. 3A-3D may be shaped like a triangular prism, and may have three capture surfaces 114 facing outward in different directions. The intake device 102 may have an opening extending vertically through the center of the intake device 102. The collection conduits 118 from the capture cells 116 on the different capture surfaces 114 may be disposed in the central opening.

The condenser 106 may be disposed directly underneath the intake device 102, and the collection conduits 118 may direct the moisture laden air into the condenser 106. The condenser 106 may extend underwater and use the cool ocean or sea water to assist in condensing the air. The main conduit 108 may extend further underwater from the outlet of the condenser 106 and extend towards the proximal landmass. The pump 110 may be disposed along the main conduit 108 underwater and pump the condensed water to shore.

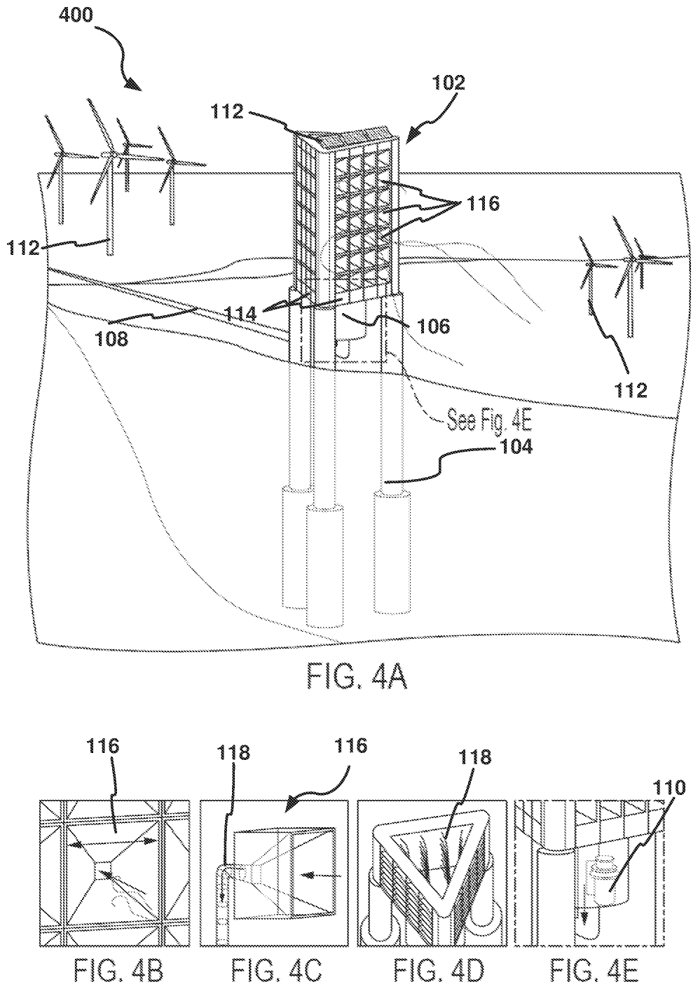

FIGS. 4A-4E illustrate another example of a freshwater generation system 400. The freshwater generation system 400 of FIGS. 4A-4E may have the same or similar components and/or a different arrangement of the components of the freshwater generation systems 100, 200, and 300 shown in FIGS. 1A-1E, 2A-2D, and 3A-3D. For example, the freshwater generation system 400 may have an intake device 102 shaped like a triangular prism, but may have a main conduit that extends to shore above the surface of the ocean or sea. The condenser 106 and pump 110 may both be located directly underneath the intake device 102.

FIG. 5A illustrates another example of a freshwater generation system 500. The freshwater generation system 500 of FIG. 5A may have the same or similar components and/or a different arrangement of the components of the freshwater generation systems 100, 20, 300, and 400 shown in FIGS. 1A-1E, 2A-2D, 3A-3D, and 4A-4E. For example, the intake device may be attached to the support structure 104 via a rotating joint that may enable the intake device 102 and capture surface 114 to be rotated to face in different directions depending on wind direction.

As shown in FIG. 5B, the condenser 106 may be disposed on the back of the capture cell 116. For example, the moisture-laden air may be captured by the capture cells 116 and funneled directly into the condenser 106, where the air flows over foils or fins of the condenser 106. The condensate may be collected and directed to the main conduit 108, and the remaining air may flow out an exhaust of the condenser 106. There may be a condenser 106 disposed at each capture cell 116, or multiple capture cells 116 may share a common condenser 106.

FIG. 6 illustrates another example of a freshwater generation system 600. The freshwater generation system 600 of FIG. 6 may have the same or similar components and/or a different arrangement of the components of the freshwater generation systems 100, 200, 300, 400 and 500 in FIGS. 1-4 and 5A. For example, the intake device 102 may have a fan 602. The fan may force or direct moisture-laden air through the capture cell 116 and into the main conduit 108. The condenser 106 may be located on the proximal landmass or shore.

FIG. 7 illustrates an example of a condenser 106 that may be used for the freshwater generation system 100, 200, 300, 400, 500, 600. For example, moisture laden air may be directed through a moist air intake 702 (e.g., by the collection conduits 118 shown in FIGS. 1-5 and 8-9). A cooling fluid inlet 704 may direct cooling fluid through the condenser 106, for example, through fins or coils of the condenser 106. The cooling fluid may condense the moisture laden air flowing through the condenser 106 past the fins or coils. The cooling fluid may exit the condenser 106 through a cooling fluid outlet 706. The condensed water may be collected and directed to the main conduit 108 through a condensate outlet 708. The remaining, uncondensed air may exit through an exhaust outlet 710.

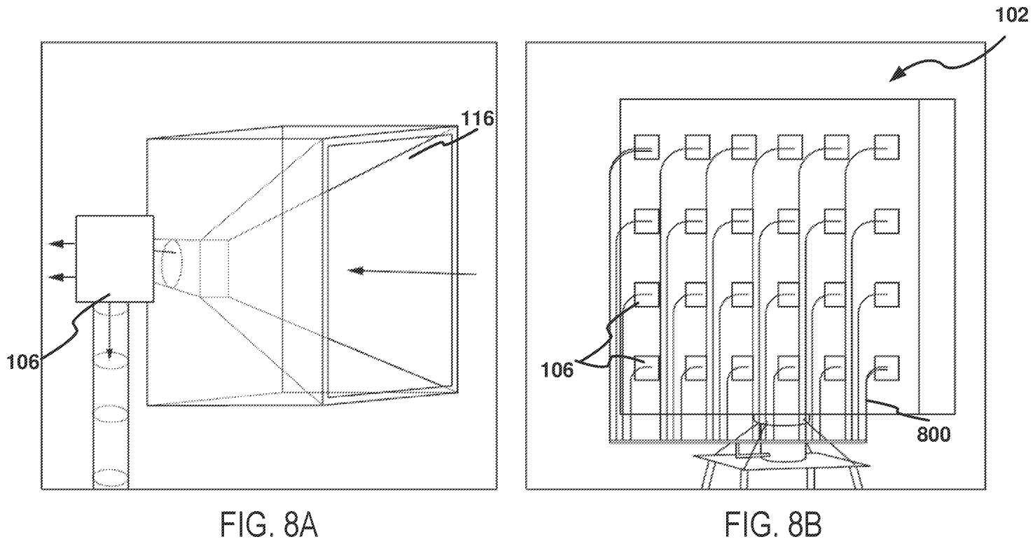

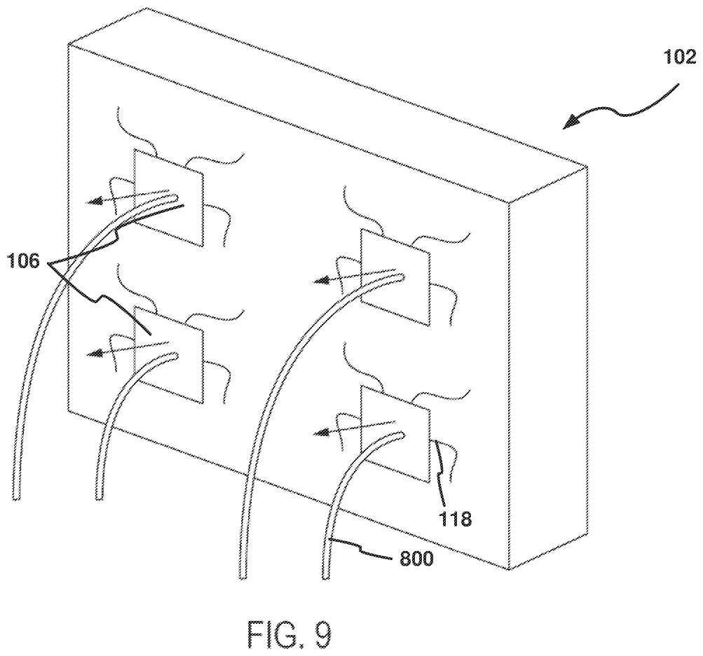

FIGS. 8A, 8B, and 9 illustrate an example of the intake device 102 and condenser 106 for the freshwater generation system 100, 200, 300, 400, 500, 600. The condenser 106 may be located on a backside of the intake device, opposite from the inlet of the capture cells 116. As shown in FIG. 8B, each capture cell 116 may have its own condenser attached to the back of the capture cell 116. The capture cell 116 may direct air directly into the condenser 106, and condensate may flow into a respective condensate conduit 800. Alternatively, as shown in FIG. 9, multiple capture cells 116 may share a common condenser 106. For example, a collection conduit 118 may flow from the back of each capture cell 116. Multiple collection conduits 118 may flow from their respective capture cells 116 to a common condenser 106, and the condensed condensate may flow from an outlet of the common condenser 106, to a respective condensate conduit 800, and to the main conduit 108.

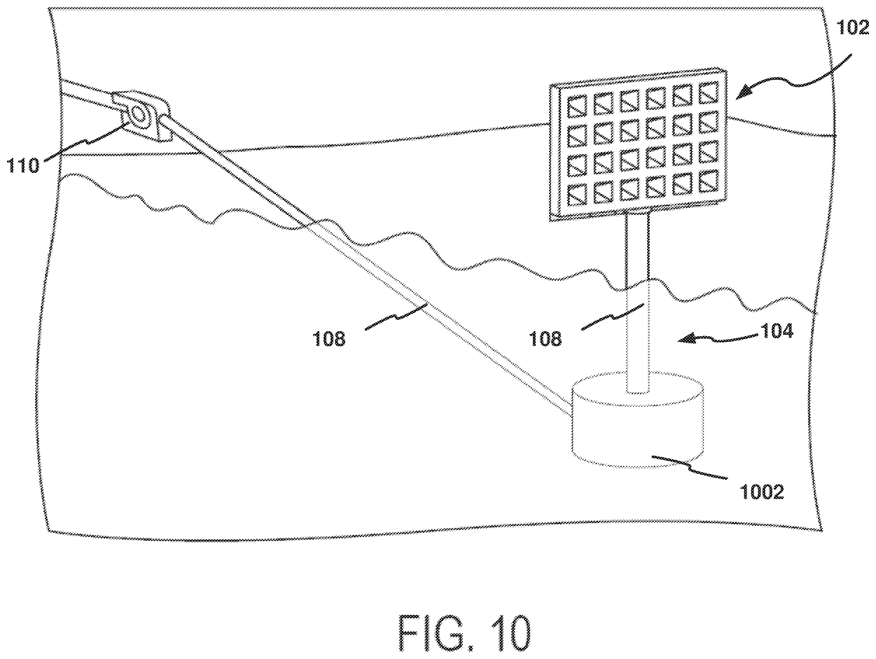

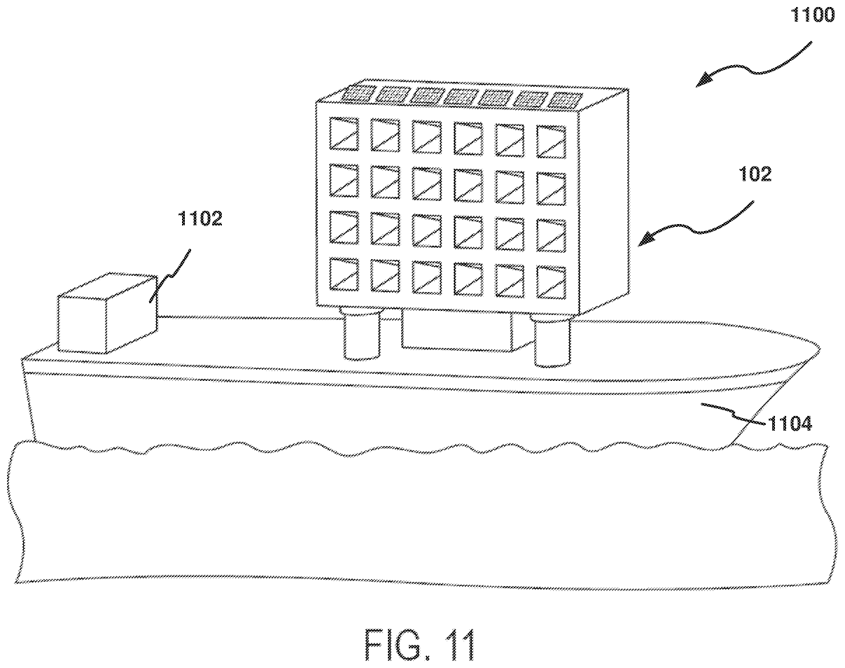

FIG. 10 illustrates an example of the intake device 102, support structure 104, main conduit 108, and pump 110 for the freshwater generation system 100, 200, 300, 400, 500, 600. The pump 110 may be disposed at the destination point, for example on a proximal landmass or shore. The pump 110 may pull or suction the condensed water towards the pump 110 through the main conduit 108. Additionally or alternatively, a tank 1002 may collect the condensed water. The tank 1002 may be disposed near the intake device 102 and support structure 104, or alternatively near the destination point, for example, on a proximal landmass. As shown in FIG. 10, condensed water may be collected in a tank 1002 underneath the intake device 102 and be pumped from the tank 1002 to a proximal landmass or nearby shore.

FIG. 11 illustrates another example of a freshwater generation system 1100. The freshwater generation system 1100 of FIG. 11 may have the same or similar components and/or a different arrangement of the components compared to the freshwater generation systems 100, 200, 300, 400, 500, 600 described above. The freshwater generation system 1100 may be disposed on a ship or large boat 1102. The ship 1102 may be any sea vessel large enough to support the intake device 102, for example, that is 100 meters tall by 210 meters wide. The ship 1102 may have an internal tank 1104, for example, within the hull of the ship, where the condensed water from the freshwater generation system 1100 is collected. The ship 1102 may sail around the sea or ocean capturing moisture-laden air and condensing the air into water. The water may be collected in the tank 1104 until the ship docks on shore where the tank 1104 may be emptied.

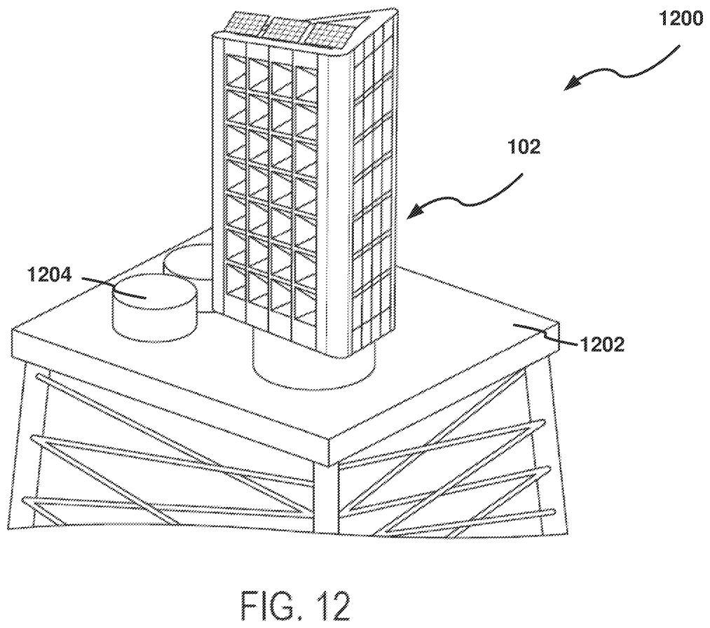

FIG. 12 illustrates another example of a freshwater generation system 1200. The freshwater generation system 1200 of FIG. 12 may have the same or similar components and/or a different arrangement of the components compared to the freshwater generation systems 100, 200, 300, 400, 500, 600, 1100 described above. The intake device 102 may be disposed on an oil rig 1202 or similar structure that is located in the ocean. Condensed water from the system may be stored in tanks 1204 located on the oil rig 1202, for example, on the platform of the oil rig. Ships may come and empty the tanks 1204 or take the tanks 1204 from the oil rig 1202 and transport the liquid water to land.

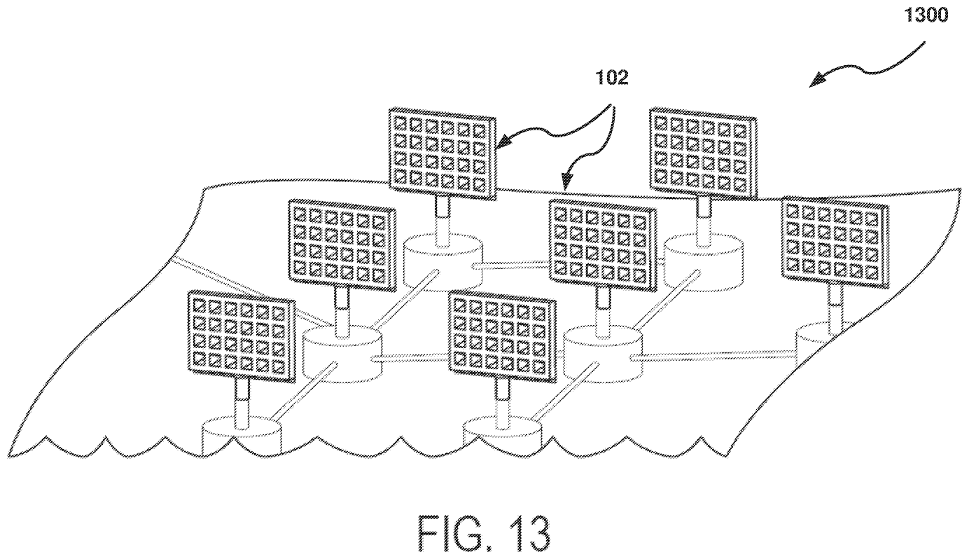

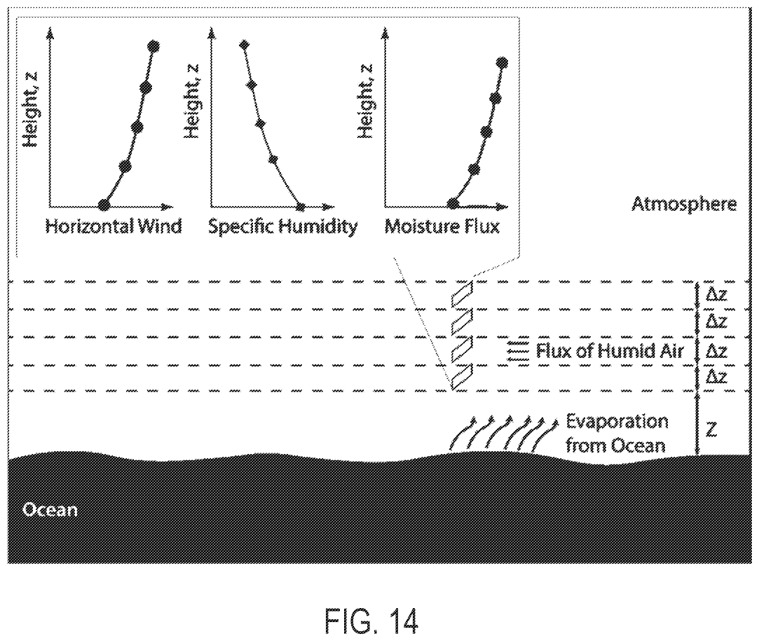

FIG. 13 illustrates another example of a freshwater generation system 1300. The freshwater generation system 1300 of FIG. 13 may have the same or similar components and/or a different arrangement of the components compared to the freshwater generation systems 100, 200, 300, 400, 500, 600, 1100, 1200 described above. The freshwater generation system 1300 may have multiple intake devices 102 and support structures 104. For example, freshwater generation system 1300 may include a farm of intake devices 102 scattered throughout an area of the ocean or sea. The intake structures may be spaced apart from one another, for example, there may be 100-200 meters between each intake device 102.

FIG. 14 illustrates a graph related to moisture flux used to calculate the quantity of water available in an atmospheric column which may be useful prior to installation and use of the freshwater generation system described in this disclosure. For example, above the ocean surface the wind velocity (U) increases while the humidity (q) decreases. The net result may be that the moisture flux MF=ρₐqU, where ρₐ=1.12 is the density of moist air, increases with altitude due to stronger wind effect. The integrated moisture flux through an atmospheric column may be approximated as the sum of the fluxes through computational layers of vertical thickness Δz and horizontal width of 1 m orthogonal to the wind direction.

The viability of the freshwater generation approach discussed above may be demonstrated by computing the quantity of extractable moisture that is available in the near surface environments above the ocean. A vertical capture surface 114 that is, for example, 210 meter wide and 100 meter tall may roughly correspond to the vertically projected area of a large cruise ship and may provide a sufficient volume of extractable moisture to meet the daily potable needs of approximately 500,000 people 30 on average. These dimensions are implemented here only as a way to illustrate that the potential volume of moisture available may be significant. It is expected that the actual implementation may encompass a variation of these dimensions based on prevailing local conditions and driven by needs and associated cost-benefit analysis. The goal of this example may be to establish that a sufficiently large volume of moisture may be obtained through the proposed approach under the prevailing conditions at various geographic locations. It may then be examined how this capacity may be impacted by climate change. An investment in such infrastructure will serve the population for decades, and it is preferable to ensure that its capacity will not degrade over time. Since such infrastructure is yet to be built, provide some thoughts on the cost structure to build and operate such facilities is provided, so they are competitive with current operational desalination plants. Since a severe shortage of freshwater in a significant part of the globe that is water stressed is a worry, the hope is that the options proposed here will serve to augment existing capacities sustainably to serve to disengage unsustainable practices.

The quantity of water that is available in an atmospheric column as the integrated water vapor flow through a vertical column in the surface sublayer of the atmosphere of height h that is 1 meter wide at a given location is first computed. Due to the non-linearity of variation through the vertical column, this is computed as the sum of moisture fluxes through discrete horizontal layers as illustrated in FIG. 14. The mean moisture flux (MF, kg/m²s or equivalently liters/m²s), which is the rate at which the mass of water in vapor phase moves horizontally per unit vertical area per unit time, is calculated as the product of the mean horizontal wind (U), the specific humidity (q), and the air density (pₐ assumed as 1.12 kg/m³ (24)). Due to the influence of surface roughness, wind speed is lowest near the surface and increases with altitude. The specific humidity is highest near the surface that serves as the moisture source, and decreases with altitude. The net effect is that the moisture flux in the atmosphere generally increases with altitude as the higher wind speed overcomes the reduction in humidity with altitude (FIG. 14). This can be scaled linearly in the horizontal for any width, w (210 meter in the illustration) to provide a good approximation of moisture flux for the considered height h.

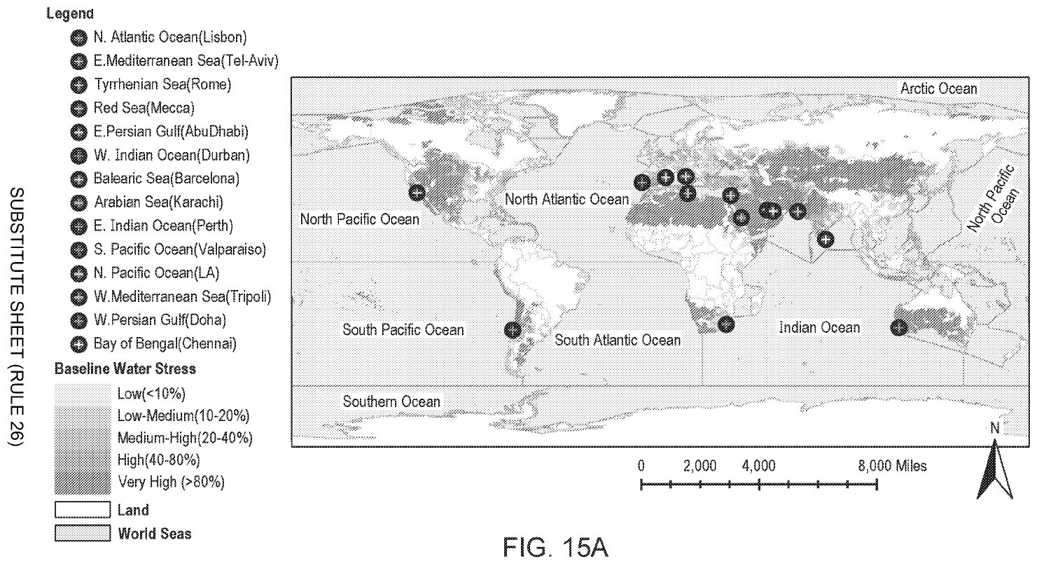

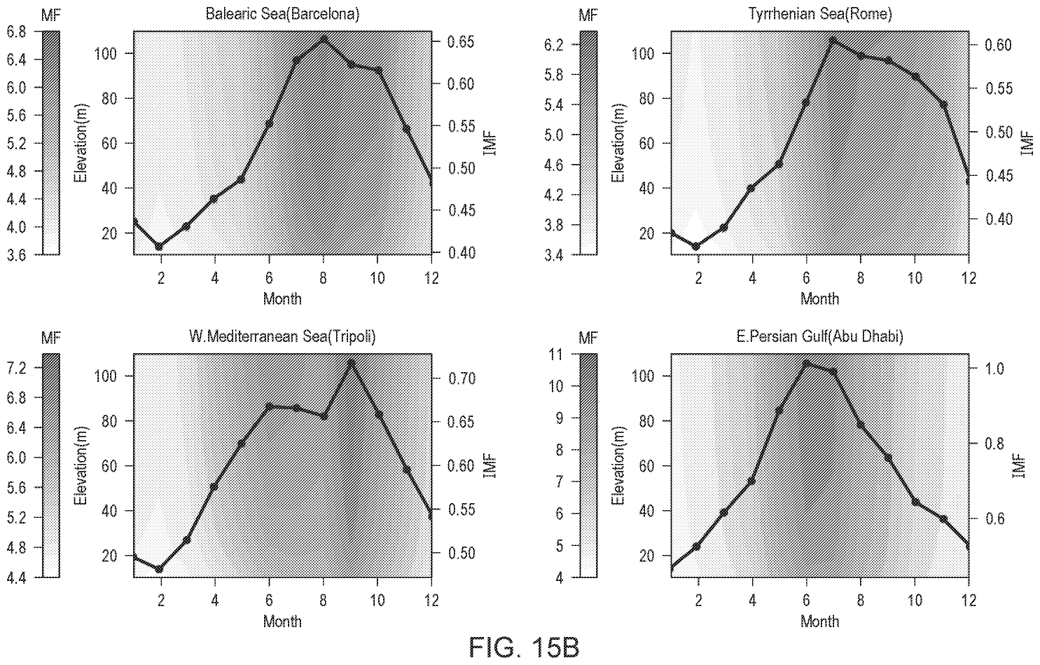

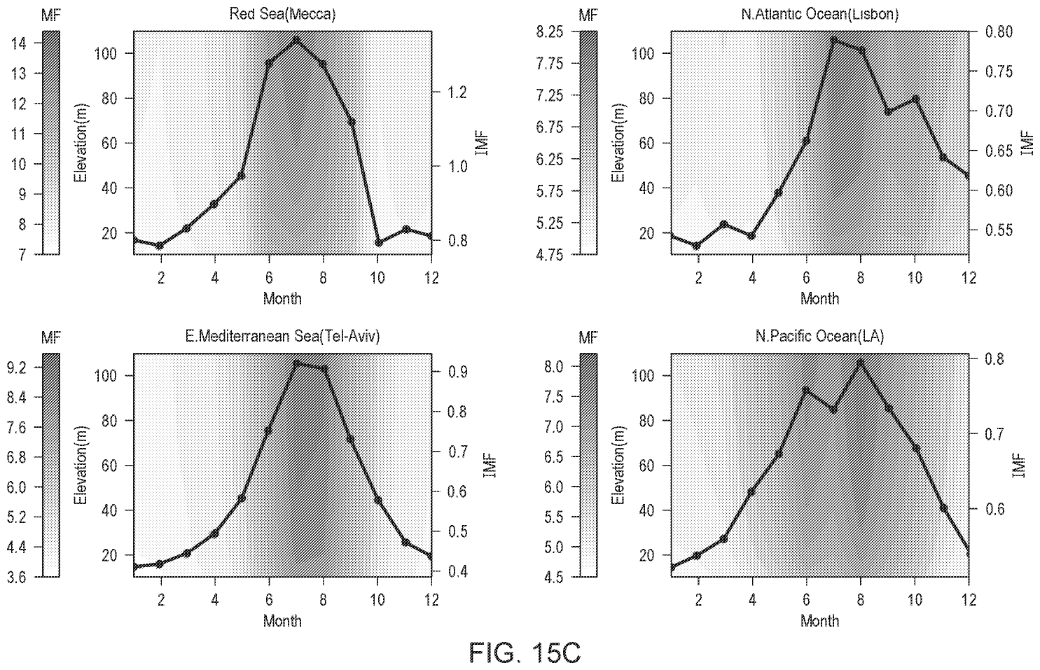

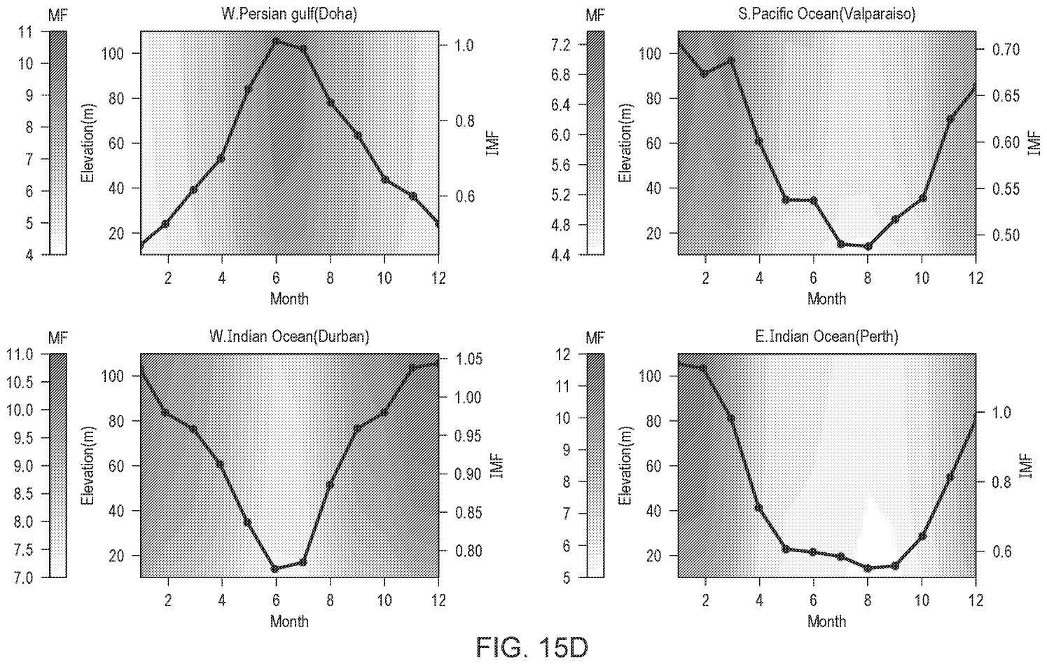

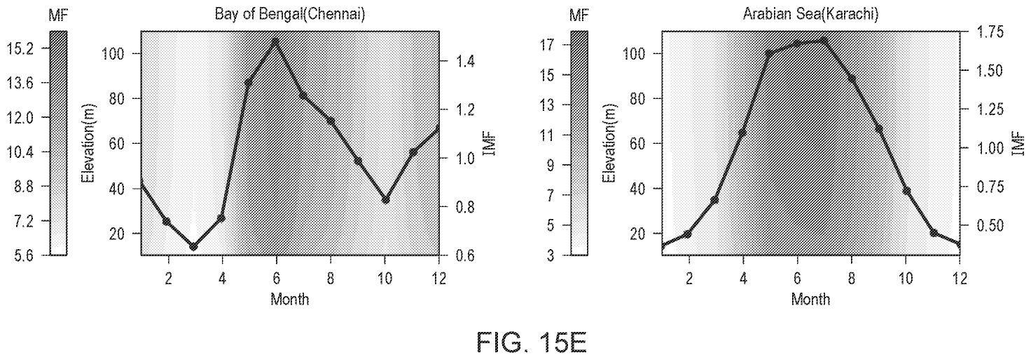

To examine if the amount of the atmospheric moisture above the oceanic surface that can be captured is sufficient for an appropriate infrastructure-based solution, the amount of moisture flux at various locations around the globe using ERAS data over a 30-year period from year 1990 to 2019 can be examined. This data is available for model grids of size 0.25°×0.25°. Grid points that are completely over the coastal environments but closest to land masses are used to compute the volume of moisture flux as a function of altitude as seen in FIG. 14. It is assumed that any infrastructure that is designed for capturing the water vapor will necessarily be placed at a certain height above the ocean surface to protect it from variations in sea-level and waves. Therefore, the first 10 meters above the surface are ignored and the daily moisture flux as a function of altitude is computed. The daily and monthly variation through a 100 meter tall (10 meter to 110 meter above sea level) atmospheric sub-layer for 14 selected locations are illustrated as shown in FIG. 15A-15E. These locations are selected close to high population centers that are near oceans across water stress regions around the globe. This selection is aimed at capturing the space-time variability of the climate across the water stressed regions of the globe. These are in the subtropical regions of both the northern and southern hemispheres, where the largest arid and semiarid areas exist. The location of the sites are available in the Table 1 below. As shown in Table 1, the average specific humidity near the selected cities ranges between 9 and 20 g/m³, while the mean annual temperature ranges between 14° C. and 30° C. Many of the sites selected have a moderate to high air temperature and a medium to high humidity levels.

TABLE 1
Average Meteorological Conditions at the Chosen Study Locations.

| Location | | | Avg. | Abs. | Avg. | | Water | |
|---|---|---|---|---|---|---|---|---|
| Ocean/Sea/ | | | Temp. | Humidity | Wind | | Stress | Population |
| Gulf | Country | City | (C.) | (g/m³) | (m/s) | Lat, Lon | Rank | (million) |
| Persian Gulf | UAE | Abu Dhabi | 27.53 | 17.3 | 4.71 | 25.38, 53.00 | 10 | 1.45 |
| Balearic Sea | Spain | Barcelona | 17.82 | 10.46 | 5.82 | 40.27, 3.75 | 28 | 1.62 |
| Bay of Bengal | India | Chennai | 27.98 | 19.78 | 5.48 | 11.15, 81.55 | 13 | 7.09 |
| Persian Gulf | Qatar | Doha | 27.53 | 17.3 | 4.71 | 25.38, 53.00 | 1 | 2.38 |
| W. Indian | South | Durban | 22.59 | 13.63 | 7.3 | −29.36, 33.75 | 48 | 5.95 |
| ocean | Africa | | | | | | | |
| Arabian Sea | Pakistan | Karachi | 26.35 | 17.38 | 5.55 | 23.53, 65.85 | 14 | 14.91 |
| N. Atlantic | Portugal | Lisbon | 16.88 | 10.02 | 6.93 | 38.42, −11.68 | 41 | 0.52 |
| Ocean | | | | | | | | |
| N. Pacific | USA | Los | 14.57 | 9.23 | 7.49 | 33.58, −122.19 | 71 | 3.97 |
| Ocean | | Angeles | | | | | | |
| Red Sea | Saudi | Mecca | 29.03 | 19.61 | 5.42 | 18.58, 39.62 | 8 | 1.58 |
| | Arabia | | | | | | | |
| E. Indian | Australia | Perth | 18.54 | 10.01 | 8.18 | −32.10, 114.19 | 50 | 1.99 |
| ocean | | | | | | | | |
| Tyrrhenian Sea | Italy | Rome | 17.97 | 10.64 | 5.27 | 40.83, 11.71 | 44 | 2.87 |
| E. | Israel | Tel-Aviv | 20.89 | 12.33 | 5.38 | 33.10, 32.56 | 2 | 0.43 |
| Mediterranean | | | | | | | | |
| Sea | | | | | | | | |
| W. | Libya | Tripoli | 20.2 | 11.89 | 5.78 | 34.23, 14.29 | 6 | 3.07 |
| Mediterranean | | | | | | | | |
| Sea | | | | | | | | |
| S. Pacific | Chile | Valparaiso | 14.39 | 8.96 | 7.03 | −32.98, −73.35 | 18 | 2.95 |
| Ocean | | | | | | | | |

FIGS. 15A-15E is a graph related to moisture flux at different geographic locations. For example, FIGS. 15A-15E illustrate the location of the 14 study sites over the ocean closest to a dominant population center are depicted on a map of water stress (center). The variation of moisture flux through an atmospheric column from 10 m to 110 m above mean sea level are also shown for each of the locations. The contour plots and line graph illustrate the change in moisture flux as a function of height and the time distribution of available water vapor, respectively. For each location, monthly averages of moisture flux (million kg/m/day) are overlain on daily flux (thousand kg/(m²day)) through the vertical column. Spatiotemporal variability of moisture flux (thousand kg/m²day) and Integrated moisture flux (million kg/m/day). The plot represent average over 30 years (1990 to 2019) obtained from ERA5 data.

FIGS. 15A-15E shows the moisture flux along the vertical and the mean integrated moisture flux for the 100 meter thick surface sublayer of the atmosphere using the 30 years of ERA-5 data. In general, at the daily time scale, the moisture flux increases slightly with altitude across all locations, consistent with the explanation provided above. The monthly average is higher during summer months as should be expected and provides the best opportunity for capturing moisture, with 30 year average in the Northern hemisphere ranging between 0.60-1.45 million liters/m/day. In general, the four summer months (June-September) can provide between 40% to 55% of the yearly total integrated moisture flux in the northern hemisphere. Among these locations, the largest peak was observed near Chennai in India, in the Bay of Bengal, owing to the monsoon effect. Also, the minimum integrated moisture flux was observed as low as 0.3 million liters/m/day in the winter months of the year in the Tyrrhenian Sea near Rome in Italy. One take away is that the amount of potential water available for capture has a seasonal variability due to variation of solar radiation, temperature and other meteorological conditions. Water availability is maximized during the warmer periods of the year, when human water demand is the highest.

The annual potential water yield across all the locations is of the same order of magnitude, even though there is a range of spatial and temporal variability in the moisture flux across these locations. This finding illustrates that coastal regions with higher water stress align with greater potential for addressing the problem by capturing moisture from atmospheric environment above ocean proximal to land. For an average consumption rate of 300 liters/capita/day (25) we see that the amount of water yield by a single 210 m wide and 100 m tall capture surface 114 can meet the needs of 0.34-0.69 million people across the selected sites with an average of about 0.5 million. We also see that the entire potable needs of the existing population in these coastal communities can be met by a handful of appropriately engineered structures (Table 2 below). The annual water yield ranging from a low of about 37 billion liters to a high of over 78 billion liters is sufficient to provide for the needs of the near-coastal population centers with less than ten facilities, with Karachi in Pakistan being an exception due to its extremely large population. The total produced water can be used for purposes other than potable water use, such as agricultural or industrial needs. Potable water is used only to offer a meaningful interpretation of the volume of water available.

TABLE 2
Assessment of volume of annual water yield from a facility of dimension 210 m in width and
100 m in height placed closest to a large city in a water stressed zone, and the numberof
people it can serve to meet their entire need estimated at 300 liters (l) per capita per day.

| | | | | No. of | | |
|---|---|---|---|---|---|---|
| | | | Annual | people | | No. of |
| | | | Potential | served | | facilities to |
| | | | Water | (million) | City | fully serve |
| Ocean/Sea/ | | | yield | at 300 | Population | the city |
| Gulf | Country | City | (Billion l/y) | l/c/d | (million) | population |
| Persian Gulf | UAE | Abu Dhabi | 54.4 | 0.50 | 1.45 | 3 |
| Balearic Sea | Spain | Barcelona | 40.4 | 0.37 | 1.62 | 5 |
| Bay of Bengal | India | Chennai | 78.3 | 0.71 | 7.09 | 10 |
| Persian Gulf | Qatar | Doha | 55.0 | 0.50 | 2.38 | 5 |
| Indian ocean | South | Durban | 71.7 | 0.65 | 5.95 | 10 |
| | Africa | | | | | |
| Arabian Sea | Pakistan | Karachi | 74.8 | 0.68 | 14.91 | 22 |
| North Atlantic | Portugal | Lisbon | 49.2 | 0.45 | 0.51 | 2 |
| Ocean | | | | | | |
| North Pacific | USA | Los | 49.7 | 0.45 | 3.97 | 9 |
| Ocean | | Angeles | | | | |
| Red Sea | Saudi | Mecca | 75.1 | 0.69 | 1.58 | 3 |
| | Arabia | | | | | |
| Indian ocean | Australia | Perth | 59.4 | 0.54 | 1.99 | 4 |
| Tyrrhenian | Italy | Rome | 37.6 | 0.34 | 2.87 | 9 |
| Sea | | | | | | |
| Eastern | Israel | Tel-Aviv | 45.7 | 0.42 | 0.44 | 2 |
| Mediterranean | | | | | | |
| Sea | | | | | | |
| Western | Libya | Tripoli | 46.1 | 0.42 | 3.07 | 8 |
| Mediterranean | | | | | | |
| Sea | | | | | | |
| South Pacific | Chile | Valparaiso | 45.2 | 0.41 | 2.95 | 8 |
| Ocean | | | | | | |

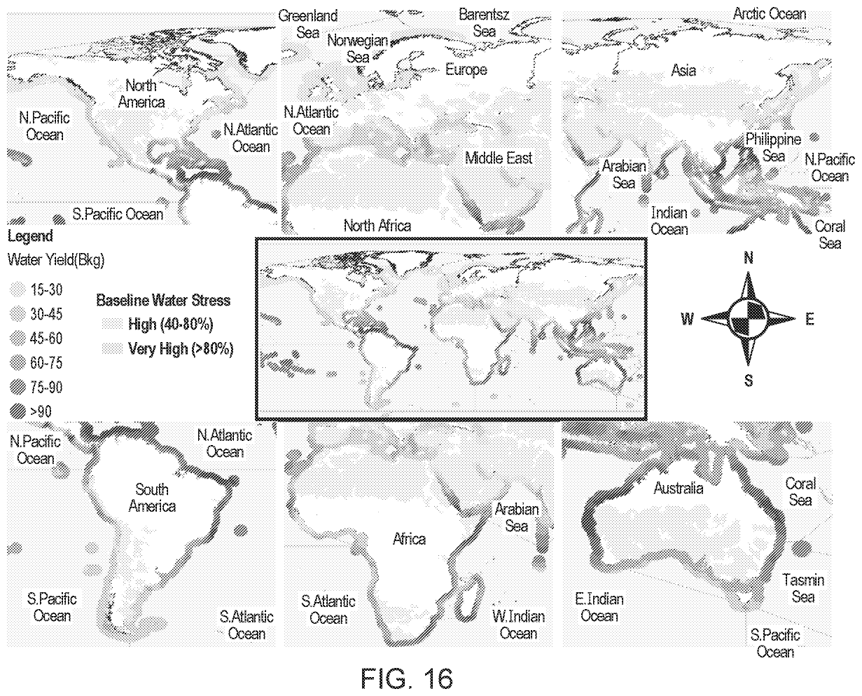

FIG. 16 is a graph related to water yield around the world. For example, FIG. 16 illustrates the spatiotemporal variability of water yield along the delineated seawater of 200 km of seawater across the world. The output stands for a hypothetical intake of 100 meters height and 210 meters in width).

To go beyond the 14 selected locations used for illustrating the feasibility of the proposed approach, a swath of 200 km over the oceans adjacent to the land along the world's coasts was delineated. The annual potential water yield from a 210 m wide and 100 m tall surface sublayer of atmosphere in a similar manner was compared. The zones for higher water yield from a thirty-year average along the continents are shown in FIG. 16. For a major part of Asia, Europe, and North America, an annual water yield of around 10 billion liters can be obtained. The northern part of South America, Eastern South Africa, and Northeastern Australia can provide an annual water yield higher than 60 billion liters. This result demonstrates that there is a significant potential to obtain freshwater across the oceans proximal to the coastal water-stressed regions. The water can also be transported significant distances inland to meet or augment needs. As a result, such infrastructure need not be located close to population centers, and their placement can be determined through other meaningful objectives.

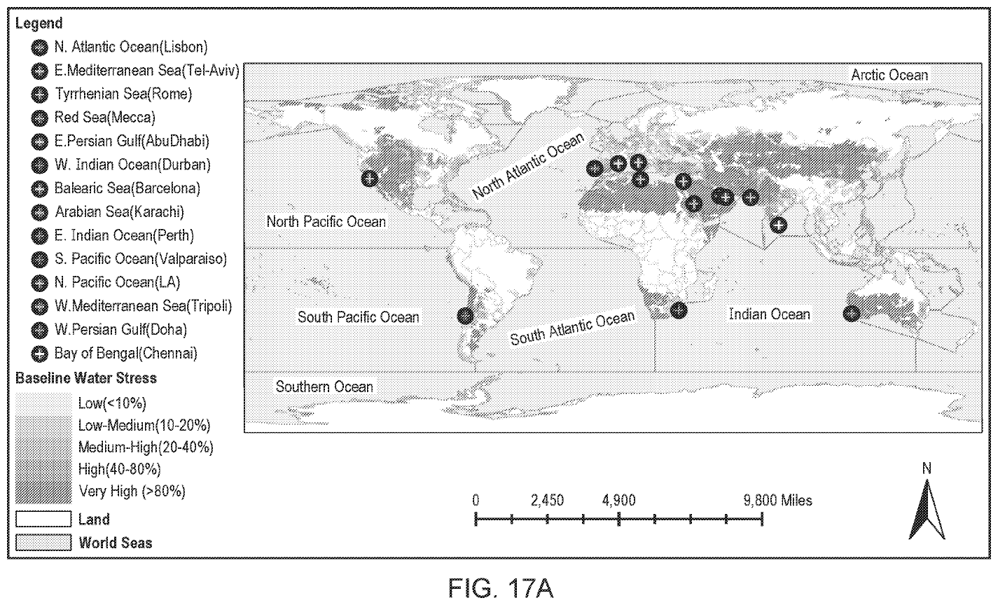

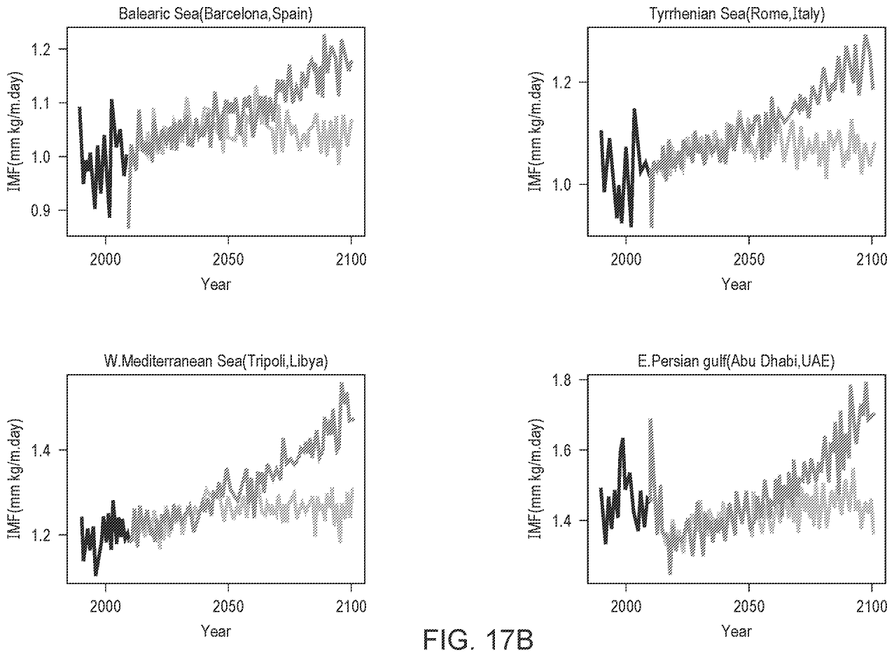

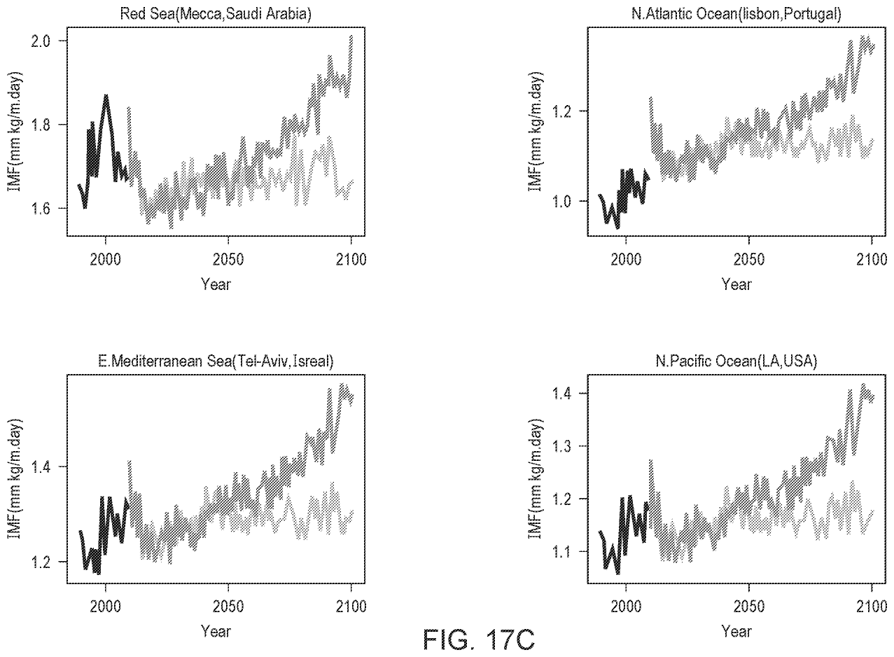

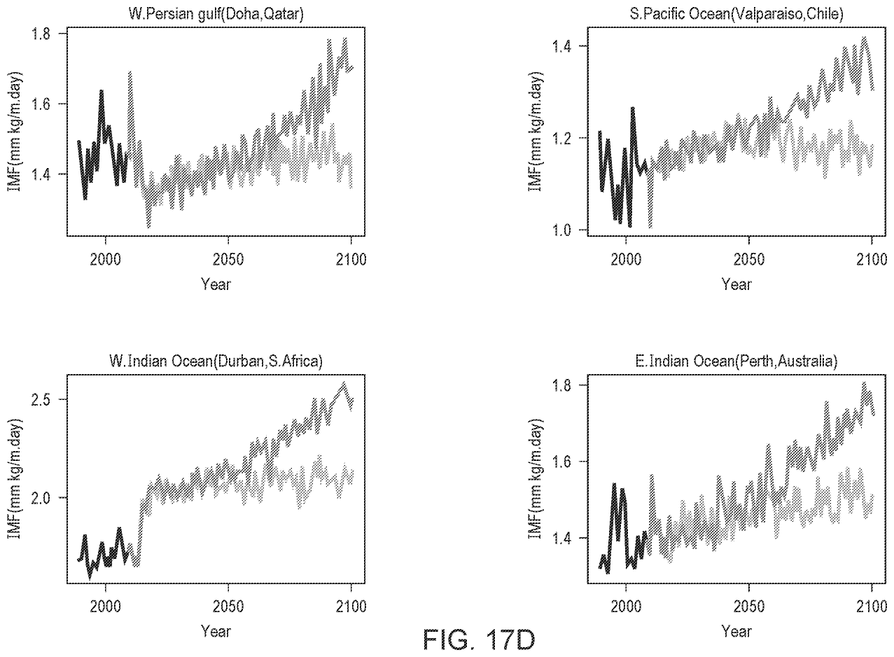

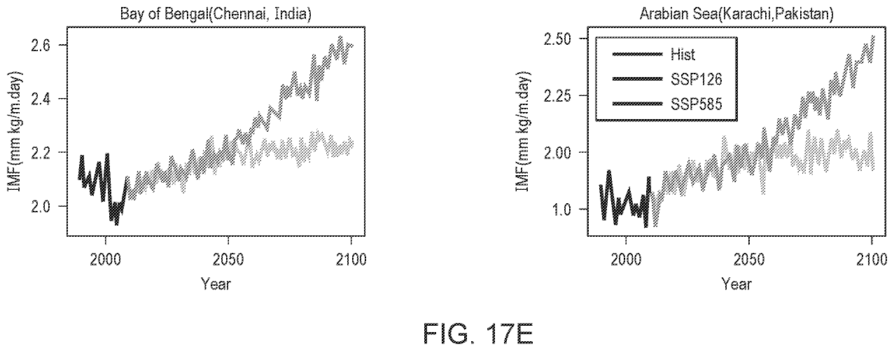

FIGS. 17A-17E is another graph related to moisture flux, and illustrates the projection of integrated moisture flux at 14 selected sites obtained from CESM2 WACCM model output. Integrated moisture flux value is in million kg per day per m width of an atmospheric column from 10 m to 110 m above the sea level. The lines indicate the historical estimate of yearly mean integrated moisture flux from 1990 to 2019, the integrated moisture flux for SSP585 scenario from 2020 to 2100, and the projection of integrated moisture flux for SSP126 scenario from 2020 to 2100.

To ensure that the feasibility established here based on the historical data remains valid for a future changing climate, the trend of moisture flux under two climate change scenarios is examined as shown in FIGS. 17A-17E. In both the SSP126 and SSP585 scenarios, the annual mean integrated moisture flux for until 2100 at all the locations does not decrease. For the SSP585 scenario, it increases everywhere, whereas for the SSP126 scenario, it remains flat for the Persian Gulf near Doha and Abu Dhabi and the Red sea near Mecca. The stationary behavior might occur due to strong subsidence in the high-pressure system. Based on this analysis, it may be concluded that the water yield from the atmosphere is not likely to decrease, and in all likelihood, the future moisture flux trajectory will be in between the trajectory obtained for the SSP126 and SSP585 scenarios, depending upon the climate change realized.

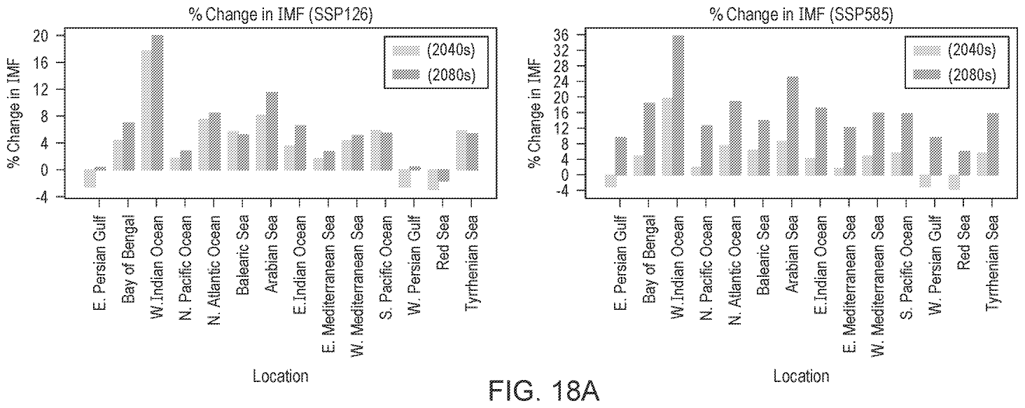

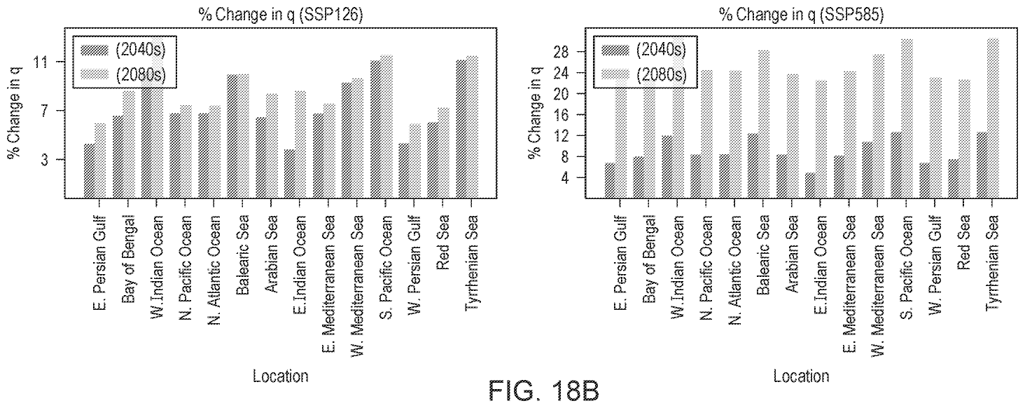

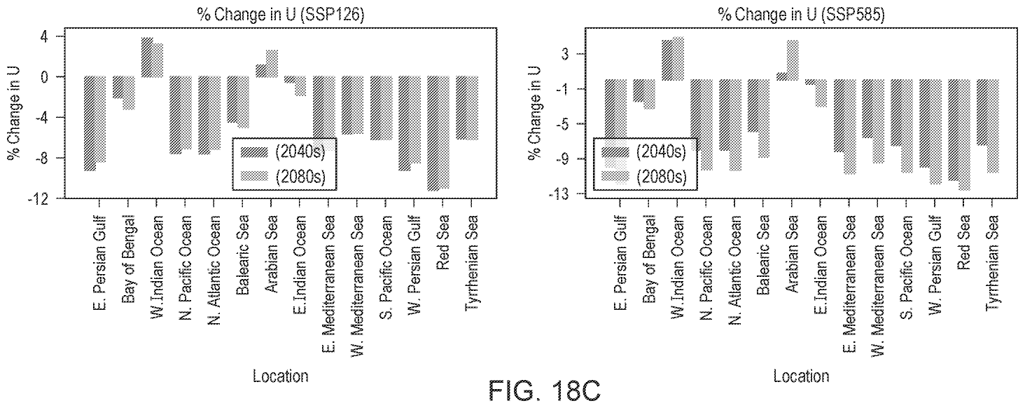

FIGS. 18A-18C is another graph related to moisture flux. FIGS. 18A-18C illustrate the percentage change in the integrated moisture flux, specific humidity and horizontal wind speed at 14 locations for SSP126 and SSP585 scenarios. 2040s and 2080s mean 30 year average from 2020 to 2059 and from 2060 to 2099, respectively.

The percentage change in the mean integrated moisture flux for two periods corresponding to 2020 to 2059 and 2060 to 2099 was also determined to compare it with the average of 1990 to 2019 for both the SSP126 and SSP585 scenarios for all 14 selected sites (as we see in FIG. 18). On average, in the SSP585 scenario, the integrated moisture flux increases by around 4% and 16% during 2020 to 2059 and 2060 to 2099, respectively. Maximum percentage increase occurs in the Western Indian Ocean near Durban in South Africa, and minimum percentage increase occurs in the Red sea near Mecca. We analyzed the corresponding percentage increase in the near-surface specific humidity and wind speed to further investigate how the integrated moisture flux might respond to the changing climate. The average increase in the near surface specific humidity of the selected sites is 9% and 25% during 2020 to 2059 and 2060 to 2099 in the SSP585 scenario. We observed a consistent increasing pattern in specific humidity at all the locations. Increased sea surface and atmospheric temperature due to global warming result in increased water vapor in the atmosphere, resulting in increased humidity. Indeed, when the atmosphere warms, saturation vapor pressure increases following the Clausius-Clapeyron equation. Over the ocean, this results in more moisture in the atmosphere. On the other hand, the percentage changes of mean surface wind speed show an opposite trend. On average, the wind speed decreases by around 5% during 2020 to 2059 and 2060 to 2099 in the SSP126 scenario and by 5% and 7% during 2020 to 2059 and 2060 to 2099 in the SSP585 scenario. The projected increase in near-surface humidity level and the decrease in the predicted wind field suggests that the projected change in integrated moisture flux is dominated by thermodynamics and is not wind-driven. The findings contribute to our assessment that the water supply from oceanic evaporation would be a sustainable approach even under the future climate.

Through the above research, it has been established that the capture of moisture over ocean surfaces is a feasible solution for many water-stressed regions of the world. The estimated water yield of the proposed intake structures 102 could alleviate the freshwater needs of large population centers in the subtropics. The average and range of the water yield establish the feasibility of the proposed approach to address water security, both under existing and future climate. This proposed system could be used as a substitute or to supplement the year-round freshwater production in areas with access to coastal water bodies or transported to distant island locations, thereby assisting in alleviating water scarcity while also maintaining ecosystems and the environment. The concept of utilizing atmospheric humidity for potable water production is different from previous articulations which include water production by radiative cooling, active cooling by vapor compression refrigeration cycle or thermoelectriccooling method and desiccant method. However, these solutions are not scalable to address water scarcity concern in a significant way because the amount of moisture flux available in the atmosphere over land is substantially smaller than the limitless oceanic sources. Small islands could serve as sites for our proposed facilities, provided that humidity and wind fields are primarily determined by the surrounding water body and not the landmass. The proposed freshwater generation system describe herein is scalable, has negligible environmental costs, and increases in capacity under warmer climate conditions. The estimates of water yield are based on assuming that all moisture carried by the ambient wind can be extracted. If suction is used, then loss in efficiency during the intake and transportation process may be overcome. The energy cost of this endeavor may also not be burdensome as moisture already evaporated by the solar energy is captured.

As an example, ERA-5 daily data with resolution of 0.25°×0.25° over oceans is used due to its agreement with a range of observed measurements. Surface data is used for 1990 to 2019 at 10 m elevation for wind speed and at 2 m elevation for air temperature, dew point temperature, instantaneous vapor flux, surface sensible heat flux, friction velocity and surface air pressure. According to the sign convention of ERA-5, vertical downward fluxes are positive. Data on specific humidity are not readily available from ERA-5 data on single levels, and therefore the daily 2-m specific humidity is estimated from dew point temperature and surface air pressure using the moist thermodynamics formulation. The saturation vapor pressure computed from the dew point temperature in the Clausius-Clapeyron equation represents the actual vapor pressure as shown in Equation 1. The 2m-specific humidity is calculated from the dependence between the actual vapor pressure and the specific humidity as shown in Equation 2, where, e is the actual vapor pressure at temperature, T; Lᵥ is the latent heat of vaporization; T_{d} is the dew point temperature; Rᵥ is the specific gas constant for water vapor (461.5 J/kg/K); q is the specific humidity at 2 m; and Pₐ is the surface air pressure at 2 m. where, e is the actual vapor pressure at temperature, T; Lᵥ is the latent heat of vaporization; T_{d} is the dew point temperature; Rᵥ is the specific gas constant for water vapor (461.5 J/kg/K); q is the specific humidity at 2 m; and Pₐ is the surface air pressure at 2 m.

$$e = 611 exp [ \frac{{L}_{v}}{{R}_{v}} ( \frac{1}{273.15} - \frac{1}{{T}_{d}} ) ] \qquad Equation 1$$

$$q = \frac{0.622 e}{{P}_{a} - 0.378 e} \qquad Equation 2$$

For the estimation of moisture flux under climate change scenarios, data is used from CESM2-WACCM GCM model with ensemble member r1i1p1 with horizontal resolution of 1°×1° from the CMIP6. CESM2 is chosen because it contains improved representation of the teleconnections with ENSO and Madden-Julian Oscillation, reduced shortwave cloud forcing biases and greater climate sensitivity. Also, CESM2 possesses better agreement with the observed trend of global land carbon accumulation. WACCM has been selected because this dataset contains the required variables for the calculation of moisture flux. SSP126 (combining SSP1 and RCP2.6) and SSP585 (combining SSP5 and RCP8.5) are chosen as climate change scenarios to compute the moisture flux and potential freshwater yield for future. SSP126 represents both an optimistic globalwarming and with minimal mitigation challenges whereas SSP585 represents the same for the pessimistic scenario.

Regarding the moisture flux estimation, moisture flux is defined as water vapor passing through a unit vertical area per unit time. The flux transported by the mean wind contributes to the mean moisture flux, and the flux transported by the eddies contributes to the turbulent component of moisture flux. Mean horizontal wind primarily dominates the advective transport of humidity, and therefore we have considered the mean advective moisture flux and ignored the turbulent component. Moisture flux is obtained as the mean of the product of the air density(ρ), specific humidity(q), and wind speed(u), as shown in Equation 3. The 100 m column is divided into 10 m thick strips and summed up the moisture flux (mᵢ) for each strip (i) to get the mean integrated moisture flux (IMF) for the layer height as shown in Equation 4. It is assumed that the moisture flux computed for a unit width can be simply scaled for smaller widths as there is no data to capture horizontal variation within the climate model resolutions.

$${m}_{i} = {ρ}_{a} \overline{{q}_{i} {U}_{i}} \qquad Equation 3$$

$$IMF = {\sum }_{i = 1}^{n} ( {ρ}_{a} \overline{{q}_{ι} {U}_{ι}} ) \qquad Equation 4$$

$$APWY = {\sum }_{d = 1}^{d = 365} ( IMF \times w \times 24 \times 3600 ) \qquad Equation 5$$

Where, (qᵢUᵢ)=\overline{\acute{q}ᵢÚᵢ}. Here q̅ᵢ̅Ú̅ᵢ̅ and \overline{\acute{q}ᵢÚ} are the mean and turbulent component of kinematic moisture flux. mᵢ is the moisture flux in kg of water/m²s for the i^{th} layer in the surface sublayer of atmosphere, ρ_{α} is the air density specified as 1.12 kg/m³, qᵢ is the specific humidity and Uᵢ is the horizontal wind which is obtained from the zonal (u) and meridional wind (v) components as Uᵢ=\sqrt{u²+v²}; w is the width of the intake of the hypothetical water vapor harvesting system. Daily potential water yield is simply the product of the integrated moisture flux (IMF) per unit width, the width of the water vapor collection system (w) and the number of seconds in a day. All the daily values are integrated to obtain the estimate for annual potential water yield (APWY) as we see in Equation 5.

For the calculation of moisture flux for each strips between heights zⱼ₊₁ and zⱼ, wind speed and specific humidity profiles are obtained from the flux profile relationship invoked from Monin-Obukhov similarity theory as shown in Equations 6 and 7, which assumes horizontal homogeneity and zero subsidence.

$${q}_{j + 1} = {q}_{j} - \frac{H}{{a}_{v} {ku}_{*} ρ} [ ln \frac{{z}_{j} + 1 - {d}_{0}}{{z}_{j} - {d}_{0}} - {Ψ}_{v} ( \frac{{z}_{j} + 1}{L} ) + {Ψ}_{v} ( \frac{{z}_{j}}{L} ) ] \qquad Equation 6$$

$${u}_{j + 1} = {u}_{j} + \frac{{u}_{*}}{k} [ ln \frac{{z}_{j} + 1 - {d}_{0}}{{z}_{j} - {d}_{0}} - {Ψ}_{m} ( \frac{{z}_{j} + 1}{L} ) {Ψ}_{m} ( \frac{{z}_{j}}{L} ) ] \qquad Equation 7$$

Since assumptions of horizontal homogeneity and zero subsidence are valid for the atmosphere above large water bodies, moisture flux in the atmosphere above marine water bodies would follow the similarity relations. Here, u_{*} is the friction velocity, d₀ is displacement height (0.001 m), ψₕ, ψᵥ and ψₘ are the flux profile function for heat, water vapor and momentum that varies de-pending on the stability of the atmospheric layer, aᵥ or aₕ is the ratio of eddy diffusivity and eddy viscosity under neutral condition, for water vapor and heat respectively and k is the von Kármán constant. Stability of the atmospheric layer is obtained from the Obukhov's Stability length, L as shown in Equation 8.

$$L = - \frac{{u}_{*}^{3} {ρ}_{a}}{{a}_{h} k [ ( \frac{H}{{T}_{a} {C}_{p}} ) + 0.61 E ]} \qquad Equation 8$$

Here, L is the stability length in meters, E is the instantaneous evaporative flux (kg/m²s), H is the sensible heat flux (J/m²s) and Tₐ is the atmospheric temperature at 2 m elevation. The mean daily moisture flux is calculated for 1990 to 2019 for each of the selected grids. The regions were extracted using the polygon shape file from the world's marine water bodies for the historical and future climate period. For the historical and future moisture flux analysis, a mean representative annual time series of moisture flux was generated from 30 consecutive years outputs of 1990 to 2100. Spatially averaging the grids gives a representative daily moisture flux time series for the selected zones. The spatially averaged integrated moisture flux is computed for historical and future climatic periods for each of the selected regions to compare the moisture flux for the selected areas across the globe. The daily fields were then averaged to monthly and yearly mean values. The specific humidity and wind speed were retrieved at a daily resolution from the selected CMIP6 model to analyze the percentage change in the upcoming decades.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed. Unless otherwise indicated or the context suggests otherwise, as used herein, “a” or “an” means “at least one” or “one or more.”

The subject-matter of the disclosure may also relate, among others, to the following aspects:
A first aspect relates to a system for fresh water generation, the system comprising: an intake device positioned above an ocean or sea surface for capture of moisture-laden air; and a condenser in fluid communication with the intake device for condensation of liquid water from the moisture-laden air captured by the intake device, wherein the intake device is disposed at or moveable to a vertical position above the ocean or sea surface where moisture flux of the moisture-laden air is at or above a predetermined value.
A second aspect relates to the system of aspect 1 wherein the condenser is located on a proximal landmass, the system further comprising a main conduit in fluid communication with the intake device and the condenser for transport of the moisture-laden air from above the ocean surface to the proximal landmass.
A third aspect relates to the system of any preceding aspect wherein the main conduit is disposed above the ocean or sea surface.
A fourth aspect relates to the system of any preceding aspect wherein the main conduit is disposed below the ocean or sea surface.
A fifth aspect relates to the system of any preceding aspect comprising at least one of a pump or fan to force the moisture-laden air to the proximal landmass.
A sixth aspect relates to the system of any preceding aspect wherein the condenser is adjacent to the intake device, the system further comprising a main conduit in fluid communication with the condenser and extending to a storage device on a proximal landmass for transport and storage of the liquid water.
A seventh aspect relates to the system of any preceding aspect wherein the main conduit is disposed above the ocean or sea surface.
An eighth aspect relates to the system of any preceding aspect wherein the main conduit is disposed below the ocean or sea surface.
A ninth aspect relates to the system of any preceding aspect comprising a pump to force the liquid water to the proximal landmass.
A tenth aspect relates to the system of any preceding aspect wherein the condenser is disposed above the ocean or sea surface.
An eleventh aspect relates to the system of any preceding aspect wherein the condenser is disposed below the ocean or sea surface.
A twelfth aspect relates to the system of any preceding aspect wherein the intake device has a capture surface with an area equivalent to an area with dimensions of less than or equal to 210 meters in width and less than or equal to 100 meters in height.
A thirteenth aspect relates to the system of any preceding aspect wherein a lowest point of a capture surface of the intake device is from 10 meters to 100 meters above the ocean or sea surface.
A fourteenth aspect relates to the system of any preceding aspect wherein the intake device is cuboidal in shape.
A fifteenth aspect relates to the system of any preceding aspect wherein the intake device is substantially shaped like a triangular prism and comprises three vertically-oriented capture surfaces each facing in a different direction.
A sixteenth aspect relates to the system of any preceding aspect comprising a plurality of intake devices spaced apart from one another above the ocean or sea surface.
A seventeenth aspect relates to the system of any preceding aspect wherein the intake device is disposed on a ship.
An eighteenth aspect relates to the system of any preceding aspect wherein the intake device is disposed on a platform structure similar to an oil rig for sea drilling.
A nineteenth aspect relates to the system of any preceding aspect wherein the intake device comprises a capture surface, the capture surface includes a capture cell to capture the moisture-laden air.
A twentieth aspect relates to the system of any preceding aspect further comprising a collection conduit in fluid communication with the capture cell and the condenser for transport of the moisture-laden air from the capture cell to the condenser.
A twenty first aspect relates to the system of any preceding aspect wherein the capture cell comprises a fan at an entrance of the capture cell.
A twenty second aspect relates to the system of any preceding aspect further comprising a plurality of condensers and a plurality of capture cells, wherein each condenser from the plurality of condensers is in fluid communication with a respective capture cell from the plurality of capture cells.
A twenty third aspect relates to the system of any preceding aspect wherein the condensers are disposed adjacent to the capture cells, the system further comprising condensate conduits in fluid communication with outlets of the condensers and with a main conduit for transport of the condensate to a proximal landmass.
A twenty fourth aspect relates to the system of any preceding aspect wherein each condenser is disposed adjacent to a respective capture cell, the system further comprising condensate conduits in fluid communication with an outlet from each condenser and with a main conduit for transport of the condensate to a storage tank.
A twenty fifth aspect relates to the system of any preceding aspect comprising a plurality of the capture cells, wherein the condenser is in fluid communication with the plurality of capture cells.
A twenty sixth aspect relates to the system of any preceding aspect wherein the intake device comprises a fan to direct the moisture-laden air into the condenser.
A twenty seventh aspect relates to the system of any preceding aspect where the capture cell includes a frusto-pyramidal or frusto-conical shaped funnel where a larger end of the funnel captures the moisture-laden air and the smaller end of the funnel is coupled to a condenser via a duct to transport the moisture laden air to the condenser.
The twenty eighth aspect relates to the system of any preceding aspect, where each funnel is coupled to one condenser disposed proximate the funnel, or a portion of the plurality of funnels is coupled to one condenser, where the one condenser is positioned below the intake device on a structure supporting the air intake device.
The twenty ninth aspect relates to the system of any preceding aspect wherein the air intake device is rotatably mounted on a structure supported on a sea bed below the ocean or sea surface, such that the air intake device may rotate into or away from a direction of wind.
A thirtieth aspect relates to a method of fresh water generation, the method comprising: positioning an intake device at a vertical position above an ocean or sea surface where moisture flux of moisture-laden air is at or above a predetermined value; capturing the moisture-laden air in the intake device positioned above an ocean or sea surface; directing the captured moisture-laden air to a condenser; and condensing water vapor from the moisture-laden air to form liquid water with the condenser.
A thirty first aspect relates to the method of aspect 30 further comprising transporting the moisture-laden air to a proximal landmass before condensing the water vapor from the moisture-laden air.
A thirty second aspect relates to the method of any preceding aspect further comprising transporting the liquid water to a proximal landmass after condensing the water vapor.
A thirty third aspect relates to the method of any preceding aspect further comprising transporting the liquid water to a storage tank.
A thirty fourth aspect relates to the method of any preceding aspect further comprising rotating the intake device about a vertical axis.
A thirty fifth aspect relates to the method of any preceding aspect wherein at least one of the intake device or the condenser is powered by at least one of solar energy, wind energy, or tidal energy.
A thirty sixth aspect relates to the method of any preceding aspect wherein condensing the water vapor includes transporting ocean water or sea water from a depth of the ocean or sea that is at a temperature colder than the moisture-laden air to the condenser, and using the ocean water or sea water as a coolant fluid to condense water vapor from the captured moisture-laden air.

In addition to the features mentioned in each of the independent aspects enumerated above, some examples may show, alone or in combination, the optional features mentioned in the dependent aspects and/or as disclosed in the description above and shown in the figures.

Although the present invention has been described in considerable detail with reference to certain embodiments thereof, other embodiments are possible without departing from the present invention. The spirit and scope of the appended claims should not be limited, therefore, to the description of the preferred embodiments contained herein. All embodiments that come within the meaning of the claims, either literally or by equivalence, are intended to be embraced therein.

Furthermore, the advantages described above are not necessarily the only advantages of the invention, and it is not necessarily expected that all of the described advantages will be achieved with every embodiment of the invention.

1. A system for fresh water generation, the system comprising:
an intake device positioned above an ocean or sea surface for capture of moisture-laden air; and
a condenser in fluid communication with the intake device for condensation of liquid water from the moisture-laden air captured by the intake device,
wherein the intake device is disposed at or moveable to a vertical position above the ocean or sea surface where moisture flux of the moisture-laden air is at or above a predetermined value.

2. The system of claim 1 wherein the condenser is located on a proximal landmass, the system further comprising a main conduit in fluid communication with the intake device and the condenser for transport of the moisture-laden air from above the ocean surface to the proximal landmass.

3. The system of claim 2 wherein the main conduit is disposed above the ocean or sea surface.

4. The system of claim 2 wherein the main conduit is disposed below the ocean or sea surface.

5. The system of claim 2 comprising at least one of a pump or fan to force the moisture-laden air to the proximal landmass.

6. The system of claim 1 wherein the condenser is adjacent to the intake device, the system further comprising a main conduit in fluid communication with the condenser and extending to a storage device on a proximal landmass for transport and storage of the liquid water.

7. The system of claim 6 wherein the main conduit is disposed above the ocean or sea surface.

8. The system of claim 6 wherein the main conduit is disposed below the ocean or sea surface.

9. The system of claim 6 comprising a pump to force the liquid water to the proximal landmass.

10. The system of claim 1 wherein the condenser is disposed above the ocean or sea surface.

11. The system of claim 1 wherein the condenser is disposed below the ocean or sea surface.

12. The system of claim 1 wherein the intake device has a capture surface with an area equivalent to an area with dimensions of less than or equal to 210 meters in width and less than or equal to 100 meters in height.

13. The system of claim 1 wherein a lowest point of a capture surface of the intake device is from 10 meters to 100 meters above the ocean or sea surface.

14. The system of claim 1 wherein the intake device is cuboidal in shape.

15. The system of claim 1 wherein the intake device is substantially shaped like a triangular prism and comprises three vertically-oriented capture surfaces each facing in a different direction.

16. The system of claim 1 comprising a plurality of intake devices spaced apart from one another above the ocean or sea surface.

17. The system of claim 1 wherein the intake device is disposed on a ship.

18. The system of claim 1 wherein the intake device is disposed on a platform structure similar to an oil rig for sea drilling.

19. The system of claim 1 wherein the intake device comprises a capture surface, the capture surface includes a capture cell to capture the moisture-laden air.

20. The system of claim 19 further comprising a collection conduit in fluid communication with the capture cell and the condenser for transport of the moisture-laden air from the capture cell to the condenser.

21. The system of claim 19 wherein the capture cell comprises a fan at an entrance of the capture cell.

22. The system of claim 19 further comprising a plurality of condensers and a plurality of capture cells, wherein each condenser from the plurality of condensers is in fluid communication with a respective capture cell from the plurality of capture cells.

23. The system of claim 22 wherein the condensers are disposed adjacent to the capture cells, the system further comprising condensate conduits in fluid communication with outlets of the condensers and with a main conduit for transport of the condensate to a proximal landmass.

24. The system of claim 22 wherein each condenser is disposed adjacent to a respective capture cell, the system further comprising condensate conduits in fluid communication with an outlet from each condenser and with a main conduit for transport of the condensate to a storage tank.

25. The system of claim 19 comprising a plurality of the capture cells, wherein the condenser is in fluid communication with the plurality of capture cells.

26. The system of claim 1 wherein the intake device comprises a fan to direct the moisture-laden air into the condenser.

27. The system of claim 19 where the capture cell includes a frusto-pyramidal or frusto-conical shaped funnel where a larger end of the funnel captures the moisture-laden air and the smaller end of the funnel is coupled to a condenser via a duct to transport the moisture laden air to the condenser.

28. The system of claim 27, where each funnel is coupled to one condenser disposed proximate the funnel, or a portion of the plurality of funnels is coupled to one condenser, where the one condenser is positioned below the intake device on a structure supporting the air intake device.

29. The system of claim 27 wherein the air intake device is rotatably mounted on a structure supported on a sea bed below the ocean or sea surface, such that the air intake device may rotate into or away from a direction of wind.

30. A method of fresh water generation, the method comprising:
positioning an intake device at a vertical position above an ocean or sea surface where moisture flux of moisture-laden air is at or above a predetermined value;
capturing the moisture-laden air in the intake device positioned above an ocean or sea surface;
directing the captured moisture-laden air to a condenser; and
condensing water vapor from the moisture-laden air to form liquid water with the condenser.

31. The method of claim 30 further comprising transporting the moisture-laden air to a proximal landmass before condensing the water vapor from the moisture-laden air.

32. The method of claim 30 further comprising transporting the liquid water to a proximal landmass after condensing the water vapor.

33. The method of claim 30 further comprising transporting the liquid water to a storage tank.

34. The method of claim 30 further comprising rotating the intake device about a vertical axis.

35. The method of claim 30 wherein at least one of the intake device or the condenser is powered by at least one of solar energy, wind energy, or tidal energy.

36. The method of claim 30 wherein condensing the water vapor includes transporting ocean water or sea water from a depth of the ocean or sea that is at a temperature colder than the moisture-laden air to the condenser, and using the ocean water or sea water as a coolant fluid to condense water vapor from the captured moisture-laden air.
